(19) United States
(12) Patent Application Publication
(10) Pub. No.: US 2024/0227036 A1
(43) Pub. Date: Jul. 11, 2024

(54) A JIG TO PERFORM TASKS ON A WORKPIECE AND ACCOMPANYING SYSTEMS, APPARATUS, AND METHODS USING SAME

(71) Applicant: SHAPER TOOLS, INC., San Francisco, CA (US)

(72) Inventors: ILAN ELLISON MOYER, Chapel Hill, NC (US); DYLAN MILLER FAIRBANKS, Alameda, CA (US); LIVIUS CHEBELEU, San Jose, CA (US); NICO WALKER, Kirchheim Teck (DE); JONAS BEILHARZ, Baiersbronn (DE); JOSEPH J. HEBENSTREIT, San Francisco, CA (US); MICHAEL RAJ KUBBA, San Mateo, CA (US); SAM ALGIE CUTTRISS, Oakland, CA (US); RUSSELL EVERETT FOGLE, San Francisco, CA (US); NOAH PADEN BERKOWITZ-MITCHELL, Oakland, CA (US); GREGORY WILLIAM HOWE, Larkspur, CA (US); ADITYA RAO, Oakland, CA (US); SHAWN MITCHELL KIRSCH, Oakland, CA (US)

(73) Assignee: SHAPER TOOLS, INC., San Francisco, CA (US)

(21) Appl. No.: 18/559,051

(22) PCT Filed: May 5, 2022
(86) PCT No.: PCT/US2022/072146

§ 371 Date: Nov. 5, 2023

Related U.S. Application Data
(60) Provisional application No. 63/201,600, filed on May 6, 2021.

(51) Int. Cl. B23B 47/28

(52) U.S. Cl. CPC B23B 47/28; B23B 2260/104

(57) ABSTRACT

A jig that allows a user to register a digital design to features on the jig such that a tool with image-based positioning capability, based on the features, can accurately perform a task on a workpiece based on the digital design. The jig may include elements to allow a user to accurately align the jig relative to features, such as corners or edges, of the workpiece. When working with workpieces having a similar geometry, the jig may be moved from one workpiece to the next to allow the user to perform different tasks, using different digital designs, without needing to reconfigure the jig or perform additional set-up on each new workpiece.

### CROSS-REFERENCE TO RELATED APPLICATION

This application claims the benefit of priority to U.S. Provisional Patent Application No. 63/201,600, titled “Clamping System” and filed on May 6, 2021, which is incorporated by reference in its entirety herein for all purposes.

### BACKGROUND

### Field of the Disclosure

This disclosure relates to the field of jigs and their usage to perform tasks on a workpiece using one or more tools. Jigs may include one or more devices that are used to maintain the correct positional relationship between a workpiece and a tool. Mechanical or visual elements may be used to achieve and maintain the correct positional relationship between a workpiece and a tool using a jig.

### Description of Related Art

Jigs may be used with tools to allow a user to mechanically align the tool relative to a workpiece. In some instances, a jig may be designed to allow a user to drill a hole a fixed distance from an edge or a corner of a workpiece, e.g., a jig for installing cabinet hardware on the front face of a cabinet drawer—see, for example, cabinet hardware jigs from Kreg Tool (https://www.kregtool.com/shop/cabinet-solutions/cabinet-drawer-shelf-jigs/cabinet-hardware-jig/KHI-PULL.html), True Position Tools (https://truepositiontools.com/product/cabinet-hardware-jig-max/), or Levoite (https://levoite.com/collections/tool/products/pro-cabinet-hardware-jig-adjustable-drill-guide). In some instances, a jig may be designed to allow a user to drill multiple holes with a fixed spacing without needing to measure distances between adjacent holes individually, e.g., a jig for drilling holes for shelf placement in a bookshelf—see, for example, shelf drilling jig from Rockler (https://www.rockler.com/pro-shelf-drilling-jig-with-1-4-shelf-drilling-bit-and-case). In some instances, a jig may be designed to allow a user to install recessed hinges on the edge of doors—see, for example, hinge jig skeleton from Trend Tool Technology (https://www.trend-usa.com/u-h-jig-c-hinge-jig-skeleton-two-part-in-case).

In some instances, a user manually adjusts the jig for a given task based on the specifics of the project (e.g., size of the workpiece, hardware being used, etc.). If the user wants to use the same jig for a different task, the user manually adjusts the jig for the new task. If, however, after completing the new task, the user needs to repeat the original task, the user must again manually adjust the jig for the original task. It is desirable to have a jig that can be configured to carry out multiple tasks with little to no manual reconfiguration of the jig when using the jig alternatingly between two different tasks.

When using a tool with a given jig, the tool may need to be manually adjusted for the jig in use (e.g., adjusting the cut depth of a router to account for the height of the jig). It is desirable for the tool to detect the jig being used and, in turn, adjust the tool or tool task parameters based on properties of the detected jig. This capability may save the user from having to repeat manual tasks related to tool set-up when using the jig multiple times.

A given jig may only be designed for a certain set of similar tasks such that a different jig is required for a different set of tasks—e.g., a jig designed for installing cabinet hardware may not be compatible for use as a jig to drill holes for shelves in a bookshelf. This leads to increased cost to the user to buy different jigs for different tasks. It is desirable to design a jig that can be used to perform multiple, different tasks.

### SUMMARY OF THE DISCLOSURE

Embodiments described herein describe a jig for providing a reference to an image-based positioning system to perform a task on a workpiece. In some embodiments, the jig may include a region which permits access to the workpiece. In some embodiments, the jig may include features to allow the image-based positioning system to determine its location relative to components of the jig. In some embodiments, the jig may include one or more elements to allow the jig to be aligned relative to an edge of a workpiece. In some embodiments, the jig elements may be designed so that they do not protrude beyond the top or bottom surface of the jig in a retracted state. In some embodiments, the jig may be positioned in the middle of a workpiece, not overlapping with an edge of the workpiece, to perform a task. In some embodiments, the jig may include a mechanical interface to allow a clamp to removably couple to the jig such that the jig may be secured to the workpiece or a worksurface on which the workpiece is placed.

Embodiments described herein describe methods, systems and non-transitory computer readable media enable an image-based positioning system perform a task on a workpiece using a digital design registered to features on a jig. In some embodiments, the jig may be mechanically aligned to the workpiece, and the task may be performed on the workpiece with the mechanical alignment of the jig being relied on to ensure proper positioning of the task on the workpiece. In some embodiments, an image-based positioning system may use features on the jig to ensure that a cutting bit, being used to perform a task on a workpiece, does not cut into components of the jig.

### BRIEF DESCRIPTION OF THE DRAWINGS

FIG. 1 illustrates a schematic of an exemplary jig.

FIG. 2 illustrates a schematic of an exemplary jig including various embodiments.

FIG. 3 illustrates a schematic illustrating a coordinate system based on measurements of datum points.

FIG. 4 illustrates a schematic view of a tool performing a task using a jig

FIG. 5 illustrates a schematic of an exemplary jig.

FIGS. 6-8 illustrate various workpiece configurations using a jig.

FIGS. 9A, B illustrate an embodiment of an optical alignment fiducial.

FIG. 10 shows an image of ShaperTape on a workpiece.

FIGS. 11-12 illustrate top views of a jig in different configurations.

FIG. 13A shows a view of a reticle.

FIG. 13B shows a cross-section view of a reticle component.

FIGS. 14A, B show views of a feature in a jig.

FIG. 15A shows a view of a feature in a jig.

FIG. 15B shows a view of a reticle in a deployed state.

FIG. 16 shows a zoomed-in view of a reticle in a deployed state.

FIGS. 17A, B show a cross-section view of a flag in a retracted and deployed state, respectively.

FIGS. 18A-D show views of a flag in retracted or deployed state.

FIGS. 18E, F show cross-section views of a flag mounting location on a jig.

FIG. 19A shows a bottom view of a jig showing a fence in a deployed state.

FIG. 19B shows a view of a jig showing components of a fence.

FIG. 20 shows a bottom view of a jig showing a fence in a retracted state.

FIG. 21 shows a bottom view of a jig showing a fence in a deployed state.

FIG. 22A shows a cross-section view of a fence in a retracted state.

FIG. 22B shows a cross-section view of a fence in a deployed state.

FIG. 23 shows a view of a clamp coupled to a jig.

FIG. 24 shows a view of a clamp.

FIGS. 25A-D show views of an insert aligned with a jig to create a keyhole interface.

FIGS. 26A-D show views of another insert aligned with a jig to create a keyhole interface.

FIGS. 27A-E show cross-section views of different embodiments of a clamp head and a keyhole.

FIG. 27F indicates the cut orientation for the cross-section views shown in FIGS. 27A-E.

FIG. 28A shows an embodiment of a clamp head and clamp arm.

FIG. 28B shows a cross-section view of a clamp head and a keyhole.

FIG. 29 shows a view of a clamp including a coupling arm.

FIG. 30 shows an image of an exemplary clamp.

FIG. 31 shows an image of another exemplary clamp.

FIG. 32 shows a view of a clamp including a clamping mechanism.

FIG. 33 shows a schematic view of a computer system.

FIG. 34 illustrates a schematic of an exemplary jig.

FIG. 35 illustrates the schematic of the exemplary jig from FIG. 34 with an added path.

FIG. 36 shows an image of a Shaper Origin tool on a jig placed on a workpiece.

FIG. 37 illustrates a schematic side view of a workbench set-up using a jig on top of a workpiece.

### DETAILED DESCRIPTION

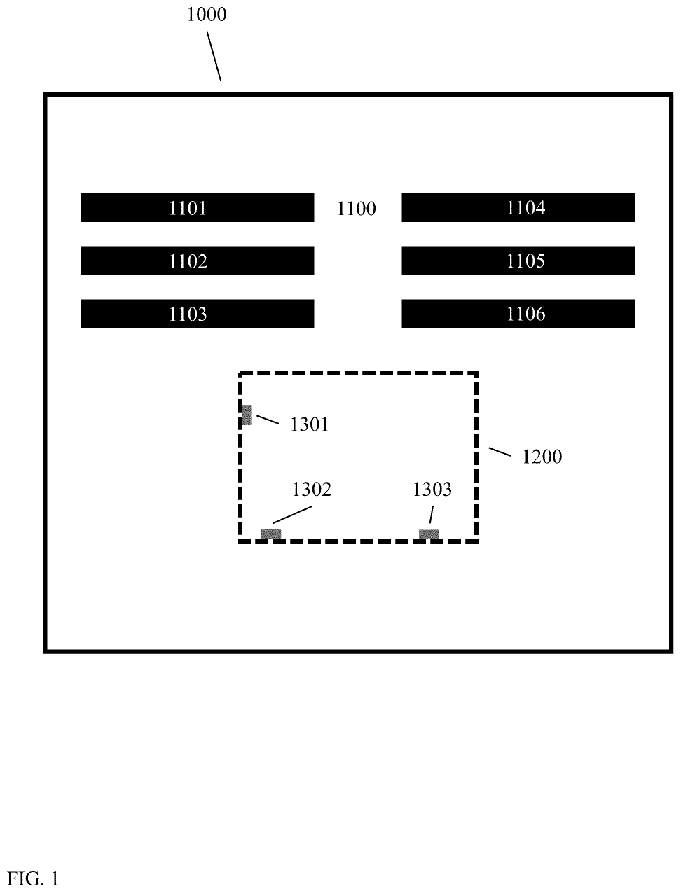

In some embodiments, a jig provides a position reference for an image-based positioning system (IBPS) while performing tasks on a workpiece. As shown in FIG. 1, a jig 1000 may comprise one or more features 1100 (i.e., 1101, 1102, 1103, 1104, 1105, 1106) that may be used by an IBPS to locate itself relative to the one or more features 1100. In some embodiments, each feature may include a unique ID to permit identification of a specific feature among the set of features. In some embodiments, each feature may be a different shape to permit identification of a specific feature among the set of features. In some embodiments, an IBPS (including, e.g., computer system 3300) may generate feature information including, for example, a list of features and their respective locations by scanning the surface of the jig using one or more cameras coupled to the IBPS. In some embodiments, feature information may include, in addition to or instead of the list of features, a map image of the features. In some embodiments, instead of scanning the surface of the jig to generate the feature information, an IBPS may receive feature information from a remote source (e.g., another IBPS, another computer system with a camera) using a communication channel (e.g., WiFi, Bluetooth) or retrieve feature information from local memory (e.g., stored from previous scan, or received previously and stored). In some embodiments, an IBPS may align a cutting bit to a path by adjusting the position of the cutting bit in one or more dimensions using one or more actuators as a user manually moves the IBPS along the path while keeping the path within an adjustment region of the IBPS. In some embodiments, an IBPS may control the motion of the cutting bit along an axis perpendicular to the workpiece. In some embodiments, an IBPS may indicate the position of a component (e.g., drill bit) on a display, leaving a user of the IBPS to align the component to design features when performing a task. For example, the IBPS may be an Origin tool from Shaper Tools, Inc., and the features may be fiducial markers on ShaperTape—see https://www.shapertools.com/en-us/origin/overview and FIG. 10, respectively. FIG. 36 shows an image of a Shaper Origin tool on a jig placed on a workpiece.

Once an IBPS has feature information for a jig, the positions of one or more features in a subsequently captured image (e.g., features 1101 and 1102) are compared to the feature information to allow the IBPS to determine the position of the camera that captured the image relative to the one or more features. The position of the camera relative to the one or more features may be determined using one or more computer vision-based mapping algorithms—e.g., methods to solve perspective-n-point problem. An IBPS may use current position data for one or more cameras to track its own position or the position of one or more of its components (e.g., position of a cutting bit controlled by the IBPS) over time. If tracking the position of a component of an IBPS, the IBPS may use information related to position offset between the component and one or more cameras (e.g., including offset between a camera and current position of a stage on which the component is mounted) to determine the position of the component relative to the one or more features based on the current position data for one or more cameras. By repeatedly capturing new images using one or more cameras and calculating positions based on feature information, an IBPS may track its position or the position of a component at 1 Hz, 3 Hz, 6 Hz, 10 Hz, 30 Hz, 60 Hz, 100 Hz, 150 Hz, or more. In some embodiments, an IBPS may track positions relative to a first coordinate system. U.S. Patent Publication No. US20190196438A1, published on Jun. 27, 2019, provides a description of a system using captured marker image data to determine cutting bit position information.

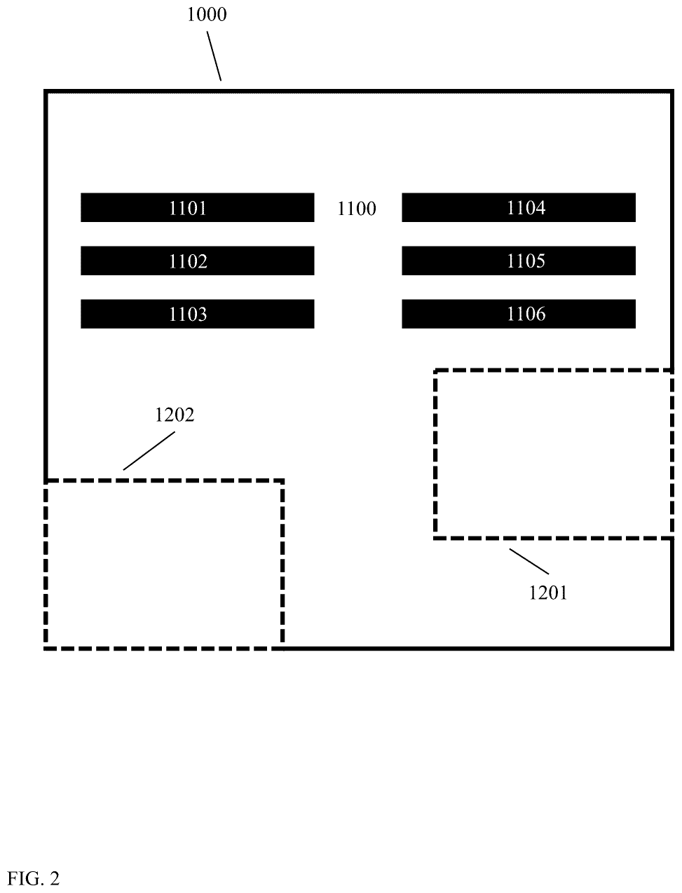

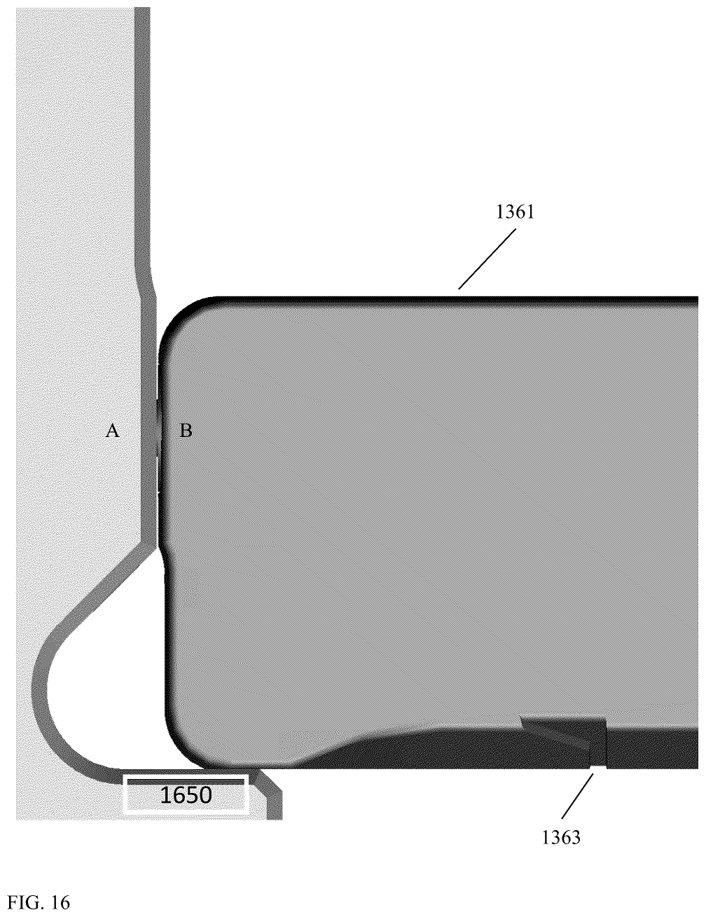

Jig 1000 in FIG. 1 includes a region 1200 to provide access to a workpiece (not shown) located underneath the jig 1000. As shown in FIG. 2, in some embodiments, the region to provide access to the workpiece may not be in the middle of jig 1000 (as shown with region 1200 in FIG. 1) but may be located along an edge (see region 1201) or may be located at a corner (see region 1202). In some embodiments, one or more datum points may be provided on the jig 1000 to allow an IBPS to probe the jig 1000 to gather information related to the geometry of jig 1000. In some embodiments, each datum point may be selected from a respective datum surface such that a user may select any point from the datum surface—for example, a point along jig 1150 surface just above box 1650 may be probed as datum point 1152, see FIG. 16 below. In FIG. 1, datum points 1301, 1302, and 1303 are provided along the edges of region 1200. In some embodiments, an IBPS may probe datum points 1301, 1302, and 1302 using a probing bit (e.g., with known diameter) to determine the positions of datum points 1301, 1302, and 1303 relative to features 1100. In some embodiments, an IBPS may use position data for datum points 1301, 1302, and 1303 to create a second coordinate system relative to a feature (e.g., bottom left corner of region 1200) of jig 1000. In some embodiments, controlling dimensions for components that set the positions of one or more elements are specified relative to one or more of datum points 1301, 1302, and 1303. In the examples provided below, machine tolerances for components that set the positions for one or more flags (1751-1754), fence (1951), or shelf pin slots (1181, 1182) are specified relative to one or more of datum points 1151, 1152, and 1153.

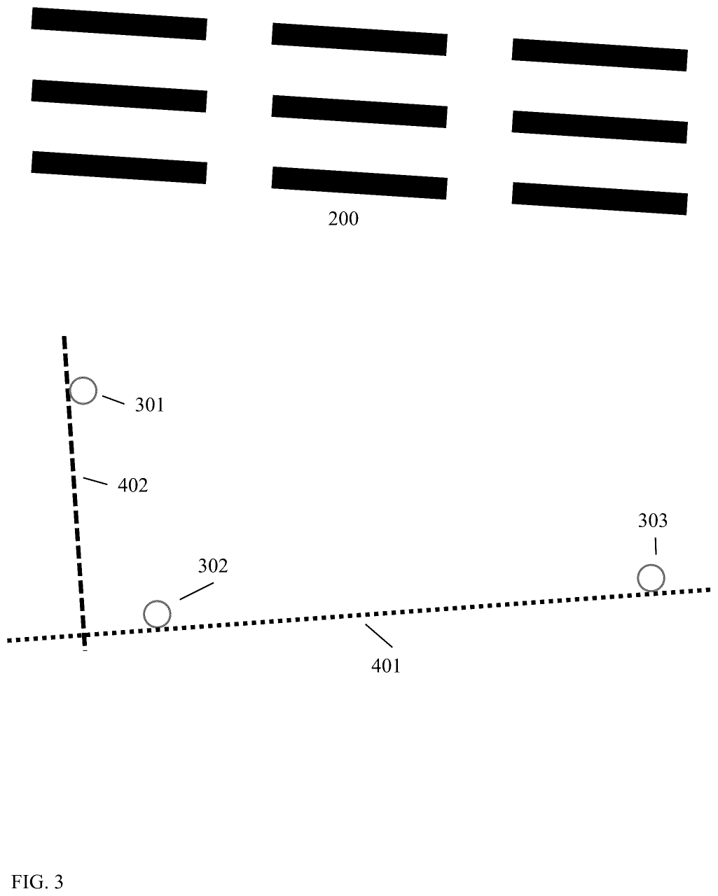

FIG. 3 illustrates probing of datum points 301, 302, and 303 using a circular probing bit to determine positions of the datum points 301, 302, and 303 relative to features 200. Using the determined positions of the datum points 301, 302, and 303, an IBPS may generate a coordinate system including horizontal axis 401 (dotted line) and vertical axis 402 (dashed line). In some embodiments, horizontal axis 401 may be identified as the line that is tangent to the bottom of probe points 302 and 303. In some embodiments, vertical axis 402 may be identified as the line that is to the left of probe point 301 and perpendicular to the horizontal axis 401. In some embodiments, the coordinate axes may align with a feature of the jig (e.g., two edges of region 1200 for jig 1000 in FIG. 1). In some embodiments, a design file for a jig may include position information for other elements of the jig relative to datum points. For example, for FIG. 1, a design file for jig 1000 may provide (1) the position of region 1200 (e.g., 4 corners), or (2) the position of the outer edge of jig 1000 (e.g., 4 corners) relative to a coordinate system based on datum points 1301, 1302, and 1303.

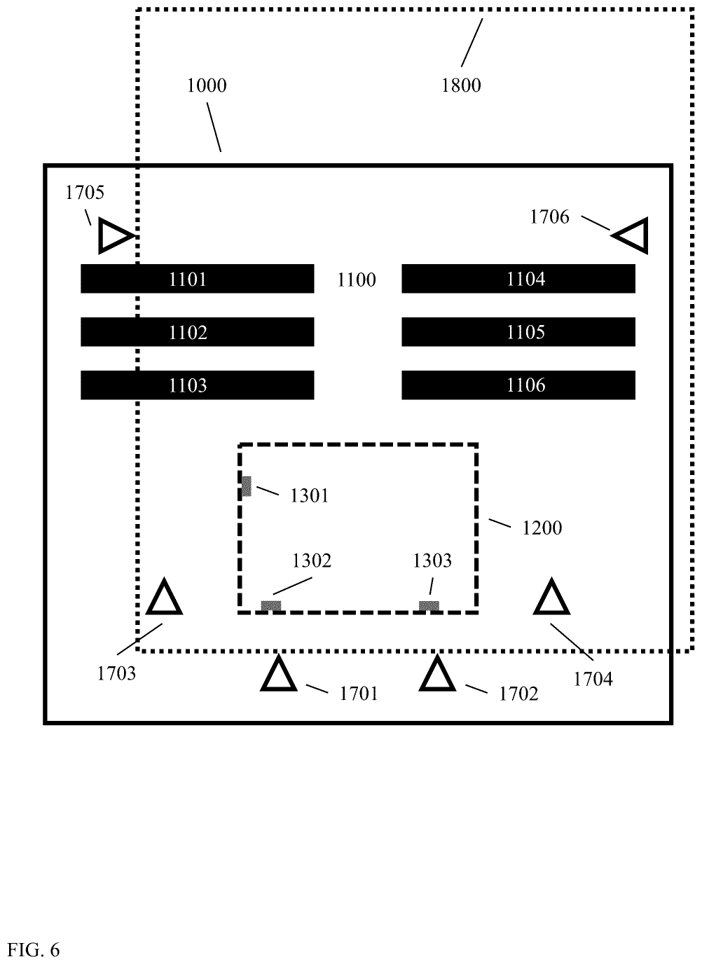

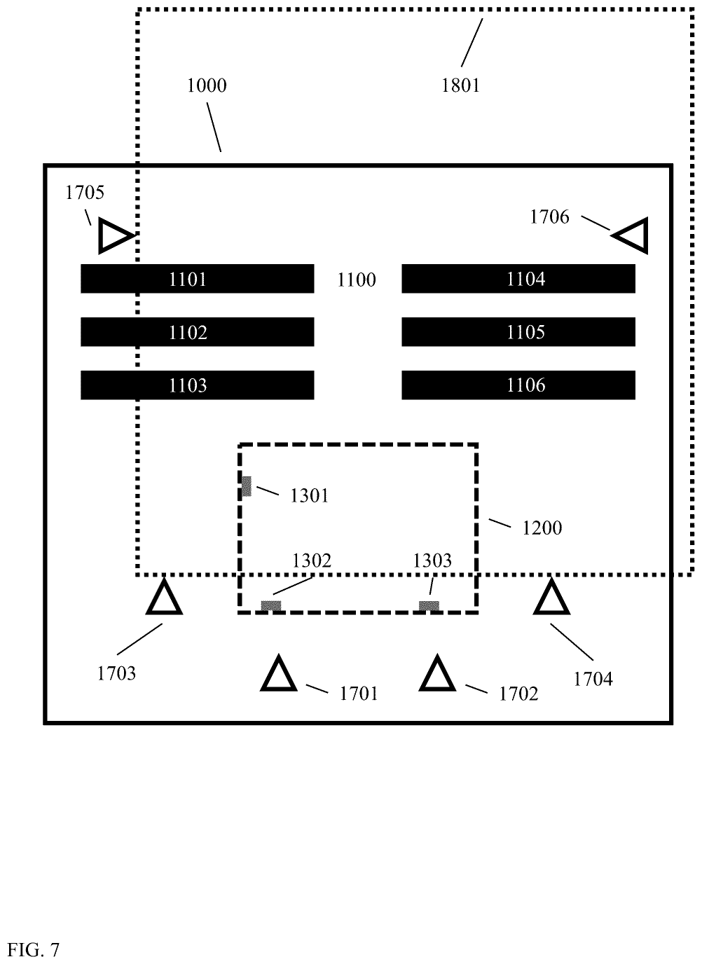

In some embodiments, an IBPS may allow a user to configure additional coordinate systems relative to an existing coordinate system. For example, a user may want to create a coordinate system which references the bottom left corner of a jig 1000 as the origin (“Coordinate System B”). If the origin of the coordinate system identified based on datum points 1301, 1302, and 1303 is the bottom left corner of region 1200 (“Coordinate System A”), Coordinate System B may be identified being shifted by −100 mm in X and −50 mm in Y relative Coordinate System A. In some embodiments, Coordinate System B may be identified based on one or more datum points where at least one of the datum points differs from datum points 1301, 1302, and 1303. Additional coordinate systems based on elements 1701, 1702, and 1705 (as described in FIG. 6, below) or based on elements 1703, 1704, and 1705 (as described in FIG. 7, below) may be defined as Coordinate Systems C and D, respectively, relative to Coordinate System A. In some embodiments, information regarding the positions of jig elements (e.g., relative to a common coordinate system, position (shift) relative to one or more other jig elements) may be provided in jig design information for the jig. In some embodiments, a user may provide design location information or task work points using a coordinate system of their choice. In some embodiments, a user may switch between different coordinate systems as they switch to using different modes of the jig (e.g., using different sets of elements, for example, as described in FIGS. 6 and 7).

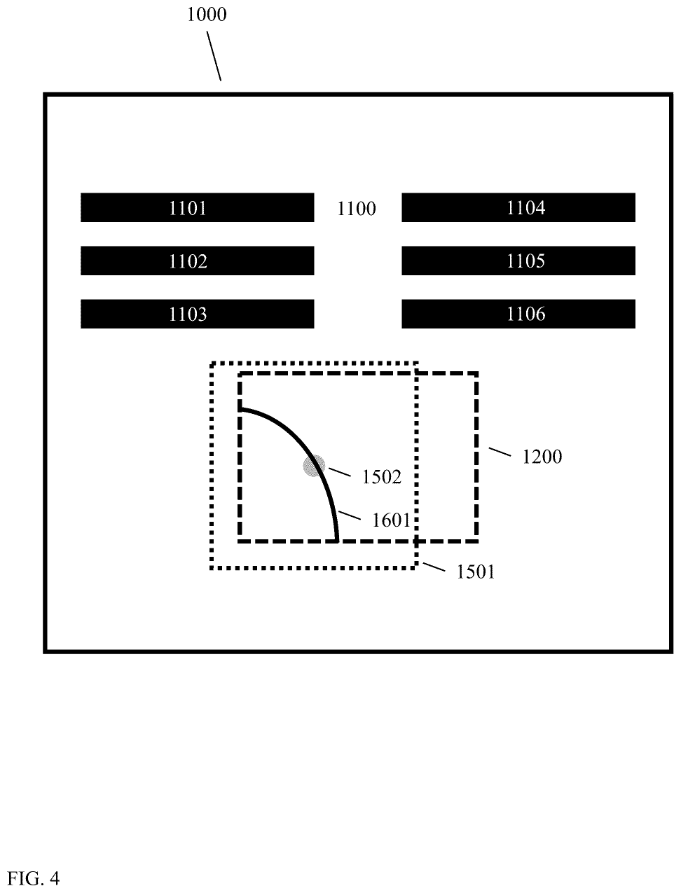

FIG. 4 illustrates an IBPS with a cutting spindle (not shown) having a base 1501 (dotted line) and an adjustment region 1502 (circle) cutting a path 1601 (solid line) on a workpiece (not shown) through region 1200. As described above, an IBPS may determine the position of a cutting bit (not shown) mounted in the cutting spindle based on feature information and captured image data showing features 1100. In some embodiments, as the user moves the IBPS to approximately follow path 1601, the IBPS adjusts the position of the cutting bit to follow the path 1601 as long as the path remains in the IBPS adjustment region 1502. In some embodiments, path 1601 may be described in a portion of a digital design received by the IBPS over a communication channel; the path 1601 may be registered to features 1100 (e.g., using feature information). Path 1601 may extend outside region 1200; for illustration purposes, only the portion of that 1601 that overlaps with region 1200 is shown. In some embodiments, path 1601 may be drawn on the workpiece using pencil, ink, or scribe, and the IBPS may follow the path 1601 using data from a camera to identify the location of the path 1601. In some embodiments, the size of region 1200 may be selected to ensure that base 1501 of an IBPS is supported by the jig (e.g., by at least two sides of region 1200) for all positions of the IBPS base encountered when the adjustment region 1502 sweeps to cover region 1200.

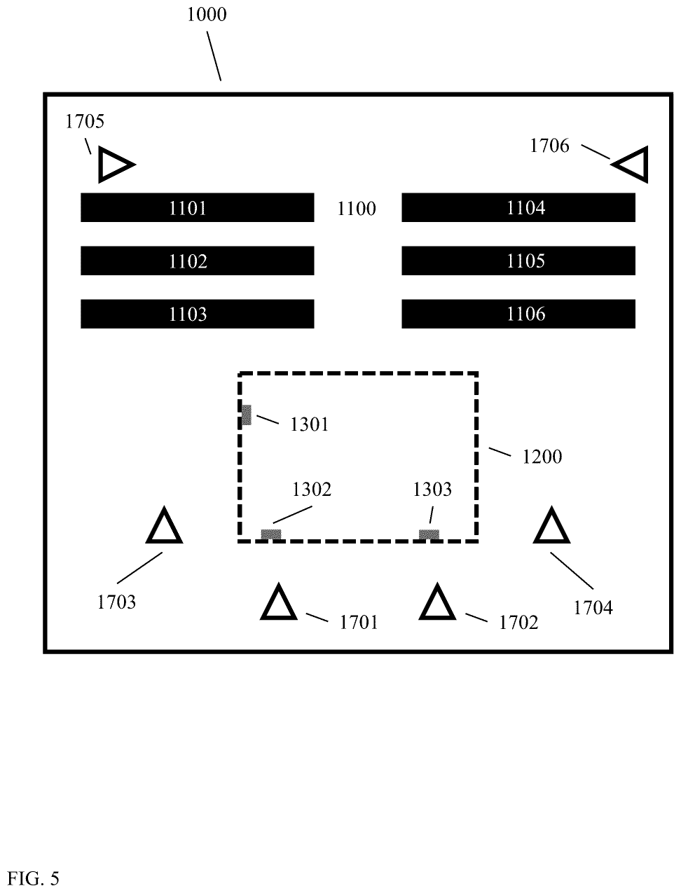

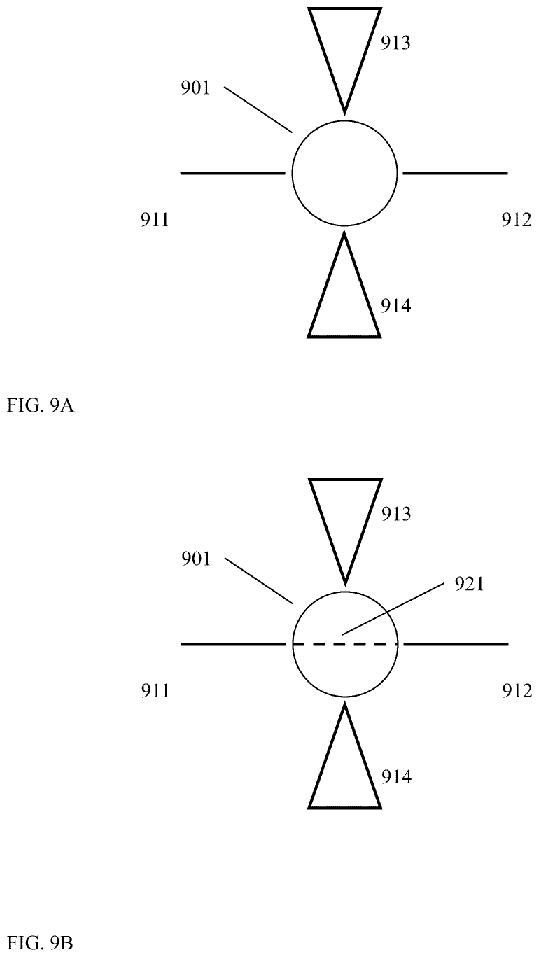

In some embodiments, a jig may include one or more elements to allow a user to align the jig to a workpiece (e.g., to a workpiece edge, to a workpiece corner). FIG. 5 shows jig 1000 with elements 1701-1706 (triangles). Each element 1701-1706 may allow a user to optically align (see FIGS. 9A, B, below) or mechanically align (see description of flag, fence, below) to a workpiece. For example, elements 1701 and 1702 may be used to align to a horizontal edge of a workpiece. Similarly, elements 1703 and 1704 may be used to align to a horizontal edge of a workpiece. Elements 1705 and 1706 may be used to align to a vertical edge of a workpiece, left vertical edge or right vertical edge, respectively.

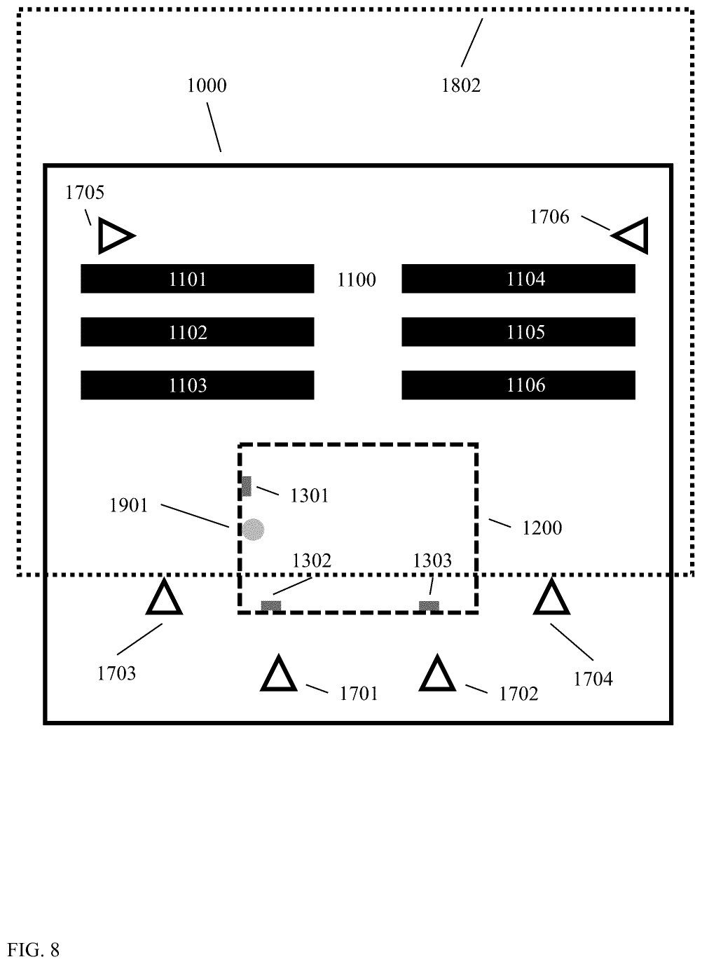

FIG. 6 shows elements 1701 and 1702 aligning to the bottom edge of workpiece 1800 with element 1705 aligning to the left edge of workpiece 1800 so that jig 1000 is aligned to a corner of workpiece 1800. FIG. 7 shows elements 1703 and 1704 aligning to the bottom edge of workpiece 1801 with element 1705 aligning to the left edge of workpiece 1801 so that jig 1000 is aligned to a corner of workpiece 1801. The jig 1000 to workpiece 1801 alignment configuration shown in FIG. 7 results in a portion of the bottom edge of workpiece being accessible in region 1200. This configuration allows a user to complete a task up to and beyond the bottom edge of workpiece 1801, for example, cutting pockets to recess a hinge on a door. FIG. 8 shows elements 1703 and 1704 aligning to the bottom edge of workpiece 1802 with jig 1000 not aligned to a corner of workpiece 1802. In order to place jig 1000 at the right location along the length of workpiece 1802, a user may add a mark 1901 (circle) on workpiece 1802 and align jig 1000 to the mark 1901 (e.g., by aligning the mark 1901 to the left edge of region 1200).

FIG. 9A shows an embodiment of an element on a jig to permit optical alignment of the jig to a workpiece. The element permitting optical alignment may include a through opening in the jig (e.g., circle, square) and one or more fiducials to align to a workpiece. Element 901 includes a hole through the jig (circular opening) and horizontal fiducials 911 and 912 (lines) and vertical fiducials 913 and 914 (triangles) marked on the jig. Fiducials may be cut, scribed, drawn, or otherwise marked on the jig. Fiducials may be the same or different. FIG. 9B shows the fiducial from FIG. 9A aligned to a horizontal edge 921 (dashed line) of a workpiece. As indicated in FIG. 9B, the horizontal edge 921 of the workpiece is visible through the opening of the jig, and a user of the jig may (manually) move the jig to align element 901 to the horizontal edge 921 of the workpiece.

FIG. 10 shows 3 strips of ShaperTape 100 on a workpiece 101. Each strip of ShaperTape includes fiducial markers with encoded patterns (“dominos”) to permit identification of markers on the tape. In some embodiments, a particular arrangement of features on the jig may permit an IBPS to recognize that a jig is being used with the IBPS. For example, an array of dominos may be arranged with a particular pattern in X and a particular pattern in Y on a jig such that, when the dominos are detected by an IBPS, the IBPS recognizes that the IBPS is using a particular jig. For example, if the dominos are arranged in a grid with a pitch of 4″ along the long axis of the domino and a pitch of 3″ along the short axis of the domino, an IBPS may recognize that pattern as indicative of a jig with a particular design—for example, based on the identified jig design data, the IBPS may determine that the jig has outer dimensions of 300 mm×400 mm, an opening to the workpiece of 220 mm×160 mm, and the bottom left corner of the opening is 40 mm in both horizontal and vertical directions from the bottom left corner of the jig.

In some embodiments, an IBPS may require that an additional feature (e.g., company logo, a shape different from a domino) is present on the jig to permit detection of the jig design—for example, to rule out false positive cases where a user arranges the dominos on their own workpiece (not a jig) in a pattern that carries part of the pattern for a known jig (e.g., long axis pitch of 4″ and short axis pitch of 3″ in the above example). In some embodiments, the detected feature pattern need not be regular (e.g., at a given pitch in any direction); the feature pattern is detected by the IBPS and tested for a match with a feature pattern for a known jig.

In some embodiments, an IBPS may provide information related to the detected feature pattern (e.g., based on feature information) to a remote server with a query to determine if the detected feature pattern matches a feature pattern for a known jig. In some embodiments, an IBPS may have a local data structure in non-volatile memory with feature pattern information for known jigs, and the IBPS can check for a match of the detected feature pattern to feature pattern for a known jig in the local data structure. In some embodiments, if a known jig is identified (e.g., based on detected feature pattern, jig identification information provided by user), the IBPS may receive jig design information from a server or access jig design information from a local memory for the identified jig. The jig design information may include information related to jig dimensions (length, width, thickness), design information for region to access workpiece (e.g., dimensions, location), design information for one or more datum points on a jig (e.g., orientation, location), or design information for one or more elements (e.g., location, geometry, orientation for optical alignment marks, flags, fences, etc.). In some embodiments, based on the jig design information, an IBPS may determine a coordinate position relative to: (1) one or more elements of a jig, (2) one or more datum points on a jig, or (3) an edge of the region to access the workpiece. In some embodiments, an IBPS may determine positions of jig components (e.g., elements, datum points, region properties) relative to the features based on the feature information and jig design information. In some embodiments, an IBPS may use the position of one or more jig components relative to the features in addition to the feature information and the jig design information to determine positions of jig components (e.g., elements, datum points, region properties).

For example, in FIG. 6, if the bottom edge of workpiece 1800 (corresponding to elements 1701 and 1702) is 100 mm below the line corresponding to datum points 1302 and 1303 and a user wants to drill a hole 200 mm in (“up”) from the bottom edge of workpiece 1800, an IBPS determines (based on jig design information) that the hole needs to be 100 mm “up” in region 1200 from the line corresponding to datum points 1302 and 1303. In this manner, the user may provide dimensions relative to the workpiece 1800 edge, and the IBPS can translate the user-provided dimension to dimensions relative to a coordinate system associated with (probed) datum points 1301, 1302, and 1303. Assuming that the X position of the hole in region 1200 is known (e.g., 10 mm to the right of datum point 1301; location of hole at 10 mm to the right and 100 mm up from the bottom left corner of region 1200), this configuration may be stored on an IBPS as a “digital” Jig A assuming the workpiece 1800 is aligned using elements 1701, 1702, and 1705.

For example, in FIG. 7, if the bottom edge of workpiece 1801 (corresponding to elements 1703 and 1704) is 100 mm above the line corresponding to datum points 1302 and 1303 and a user wants to drill a hole 50 mm in (“up”) from the bottom edge of workpiece 1801, the IBPS determines (based on jig design information) that the hole needs to be 150 mm “up” in region 1200 from the line corresponding to datum points 1302 and 1303. In this manner, the user may provide dimensions relative to the workpiece 1801 edge, and the IBPS can translate the user-provided dimension to dimensions relative to a coordinate system associated with (probed) datum points 1301, 1302, and 1303. Assuming that the X position of the hole in region 1200 is known (e.g., 100 mm to the right of datum point 1301; location of hole at 100 mm to the right and 150 mm up from the bottom left corner of region 1200), this configuration may be stored on the IBPS as a “digital” Jig B assuming the workpiece 1801 is aligned using elements 1703, 1704, and 1705.

A user can recall either “digital” Jig A or B from memory and, assuming the workpiece is aligned using elements 1701 and 1702 for “digital” Jig A or using elements 1703 and 1704 for “digital” Jig B, drill the corresponding hole in the correct location using the same jig and the IBPS with no additional set-up required. The alignment of the workpiece to the appropriate set of elements is facilitated by: (1) optical alignment using the elements (e.g., see FIG. 9), in some embodiments, or (2) mechanical alignment using elements (as described below, e.g., flag, fence), in some embodiments. In some embodiments, the capability to switch between different sets of mechanical alignment elements while maintaining tight dimensional tolerances also facilitates efficient switching between different jig configurations.

A table manufacturing company may want to mark each table with a logo specific to that table's product line, e.g., product line 1, product line 2, etc. If the logo is to be carved into a tabletop at a fixed location relative to a corner of a table, using a jig described herein, a user can align jig to the corner and select the digital design for the logo which matches the product line for the table being marked. The logo digital design (including paths required to carve the logo into the tabletop) may be referenced relative to jig elements used to align the jig to the tabletop, and an IBPS may carve the logo using features on the jig for positioning—no additional set-up of the IBPS (e.g., scanning features on the jig multiple times) or the tabletop (e.g., applying features (e.g., ShaperTape)) may be required. As described above, the jig combines the benefits of workpiece alignment (e.g., using jig elements for optical or mechanical alignment) and design flexibility (e.g., using different digital designs). In a traditional jig, in order to have design flexibility, a user would have to manually configure or adjust the jig features to match the design they want to implement. Using the jig described herein, the manual task of adjusting the jig is replaced by updating a digital design registered to the jig features (e.g., using feature information) on the jig relative to jig elements to be used for the task.

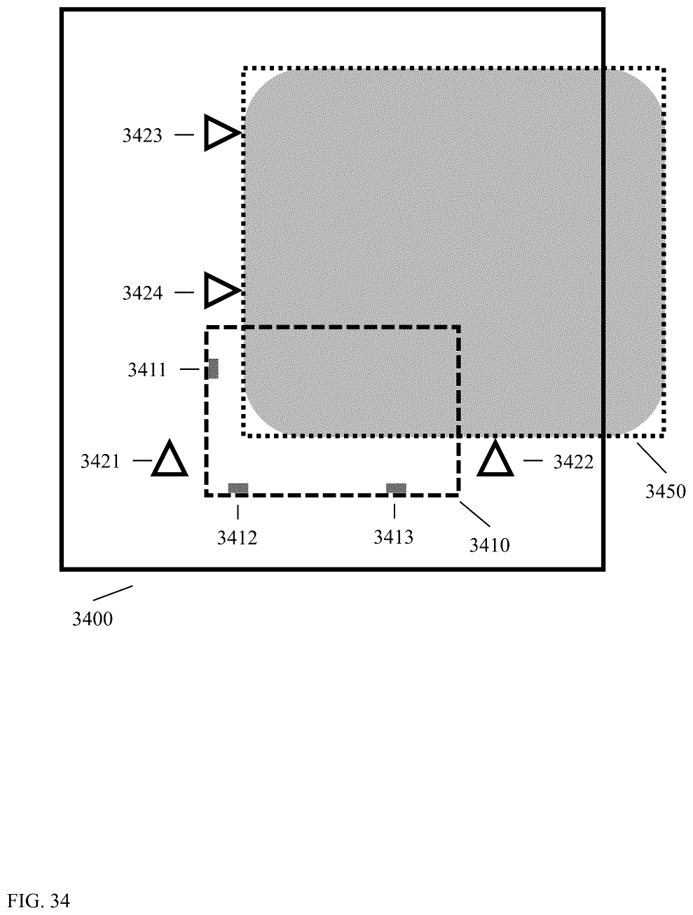

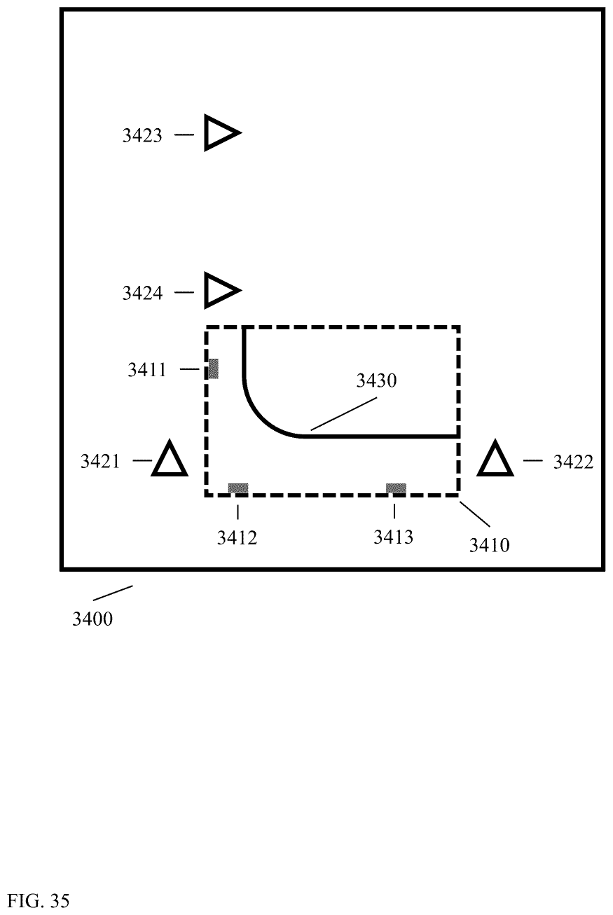

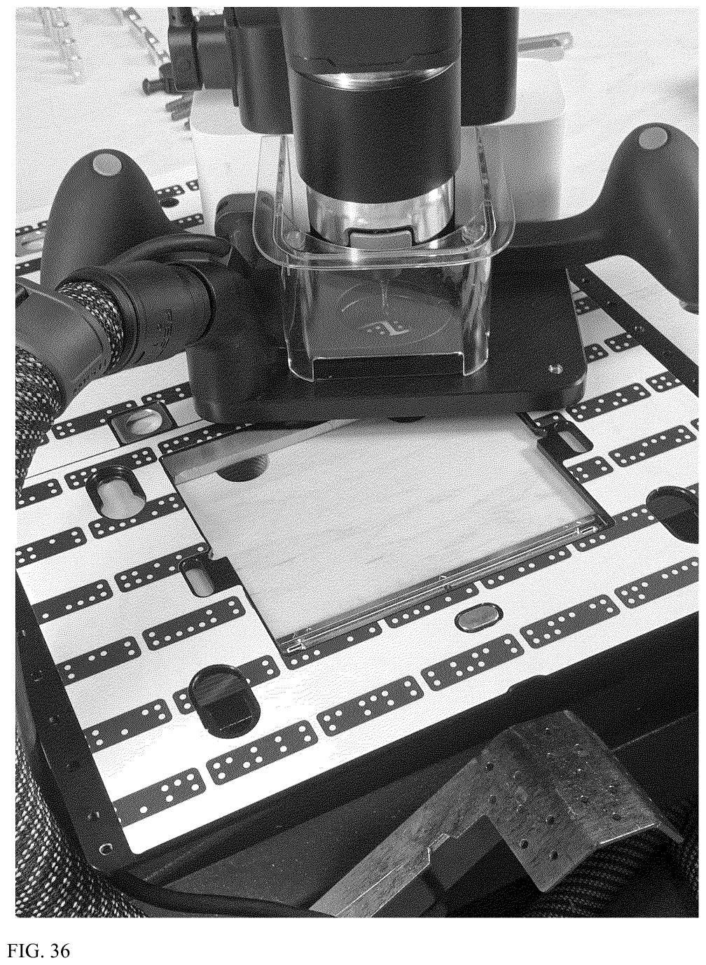

FIG. 34 illustrates a configuration of an exemplary jig 3400 (edge shown as solid line) including workpiece access region 3410 (dashed line) with datum points 3411, 3412, and 3413. Jig 3400 also includes elements 3421 and 3422 for alignment to a horizontal workpiece edge and elements 3423 and 3424 for alignment to a vertical workpiece edge. For illustration purposes only, some components of jig 3400 (e.g., features for position detection by an IBPS) are not shown. A user may want to configure the jig 3400 to round a corner of a workpiece to have a certain radius—for example, modifying a workpiece 3450 (dotted line) to have rounded corners as illustrated by the gray box. A user may register a digital design including path 3430 to the jig features on an IBPS such that the path 3430 is aligned to elements 3422, 3423, and 3424 of jig 3400 as shown in FIG. 35.

With the jig 3400 configured with path 3430 as described above, the jig 3400 may be aligned to a workpiece corner using elements 3422, 3423, and 3424, and the workpiece corner radius may be modified to match the desired radius using an IBPS without any additional setup on the workpiece—for example, all four corners of a workpiece may be modified to have the desired radius by simply aligning the jig 3400 to each corner and performing the cut using the IBPS. If the user wants to change the radius for a new workpiece, the user may register a new design with a different radius on the IBPS and perform the task on the new workpiece using the same reference elements.

In some embodiments, path 3430 may exclude some portion of the straight segments of illustrated path 3430. In some embodiments, the IBPS, when rounding the corner for a workpiece, may follow only a portion of illustrated path 3430—e.g., not cutting some portion of the straight segments of path 3430. In some embodiments, to enable repeatable path to workpiece alignment, the position repeatability of one or more elements (e.g., flags, fence) in the deployed stage (e.g., after one to 100 retraction and deployment cycles) may be better than 500 um, 400 um, 300 um, 200 um, 150 um, 100 um, 50 um, or 25 um.

In some embodiments, based on jig thickness information (e.g., from jig design information), an IBPS may adjust the cut depth to account for the jig thickness. For example, if a user wants to make a cut extending 5 mm into the workpiece and the jig thickness is 5 mm, an IBPS can adjust the cut depth to 10 mm to account for the thickness of the jig. In some embodiments, an IBPS may probe the top surface of the jig and the top surface of the workpiece in the region open to the workpiece to determine the thickness of the jig—see, for example, U.S. Patent Publication No. US20180126507A1, published on May 10, 2018, including description of “workpiece” thickness probing. In some embodiments, a cutting depth of an IBPS may be limited, and, in such instances, it is preferable to preserve the work envelope for the IBPS when a jig is being used for a task. Hence, a jig may be less than 20 mm, 15 mm, 10 mm, 8 mm, 6 mm, 5 mm, or 4 mm thick. In some embodiments, the jig may have topographical features (e.g., partial or fully through trenches, screw holes, cut outs, etc.) within the area defined by the outside perimeter of the jig. A top planar surface area of the jig may be defined as the top area of the jig assuming that any topographical features are filled up to the plane on which an IBPS rests during work on a workpiece using the jig.

In some embodiments, an IBPS may designate an exclusion zone such that a cutting bit does not cut into the jig (e.g., the edge of the region 1200) during a cutting task. In some embodiments, the location of the region 1200 relative to features 1100 may be determined based on probing of datum points 1301, 1302, and 1303 along with design information (e.g., length, width) for region 1200 (e.g., from jig design information). In some embodiments, an IBPS may exclude the cutting bit from getting closer than 25 mm, 20 mm, 15 mm, 10 mm, 8 mm, 5 mm, or 3 mm from a jig exclusion zone (e.g., the edge of region 1200). In some embodiments, an IBPS may display a message in a GUI of a display, sound an audible alert, retract the cutting bit into the IBPS (above the bottom of the base of the IBPS), or turn off the cutting spindle if the cutting bit is 25 mm, 20 mm, 15 mm, 10 mm, 8 mm, 5 mm, 3 mm, or less from a jig exclusion zone. For example, an IBPS may display a message in a GUI if the cutting bit is 25 mm from a jig exclusion zone. The IBPS may sound an audible alert if the cutting bit continues to move towards the jig exclusion zone and is within 20 mm of the jig exclusion zone. The IBPS may retract the cutting bit if the cutting bit still continues to move towards the jig exclusion zone and is within 10 mm of the jig exclusion zone. The IBPS may turn off the cutting spindle if the cutting bit still continues to move towards the jig exclusion zone and is (when projected to the top surface of the jig) within 5 mm of the jig exclusion zone. In some embodiments, an IBPS may detect (e.g., based on a captured image and object detection/identification) or may receive information regarding the mechanical state of the jig (e.g., fence, described below, is deployed), and the IBPS may modify the jig exclusion zone accordingly—for example, excluding the cutting bit from the region overlapping with a deployed fence. In some embodiments, an IBPS may change the trigger action based on the design of the jig. For example, if the IBPS is approaching an edge corresponding to a fence, it may display a message on the GUI of a display requesting the user to confirm that the fence is retraced. If the IBPS is approaching an edge that does not have a fence, the IBPS may not display the message (e.g., based on jig design information).

In some embodiments, with an IBPS controlling the motion of the cutting bit to keep the cutting bit on a path, the IBPS may trigger an action based on a prediction of the IBPS motion relative to a jig exclusion zone For example, in some embodiments, the IBPS may predict that the cutting bit may encounter a jig exclusion zone at a future time (e.g., 500 ms, 200 ms, 100 ms, 50 ms, 20 ms or less) if the IBPS continues its current motion (e.g., based on its position, speed, acceleration, or the like) and trigger an action (e.g., retract the cutting bit into the IBPS) based on the prediction. For example, in some embodiments, the IBPS may predict the motion of the cutting bit relative to a jig exclusion zone at a future time (e.g., 500 ms, 200 ms, 100 ms, 50 ms, 20 ms or less) based on one or more of: the current motion of the cutting bit (e.g., relative to die IBPS, in the adjustment region), the current motion of the IBPS (e.g., relative to the jig), and the path that is being followed by the IBPS. In some embodiments, based on a prediction at a future time (e.g., in 50 ms), an action may be triggered with a larger distance between the cutting bit and a jig exclusion zone if the cutting bit is moving quickly towards the jig exclusion zone, and an action may be triggered with a smaller distance between the cutting bit and the jig exclusion zone if the cutting bit is moving slowly towards the jig exclusion zone—see, for example, WIPO Publication No. WO2021168475A1, published on Aug. 26, 2021, including description of exclusion and activity zones.

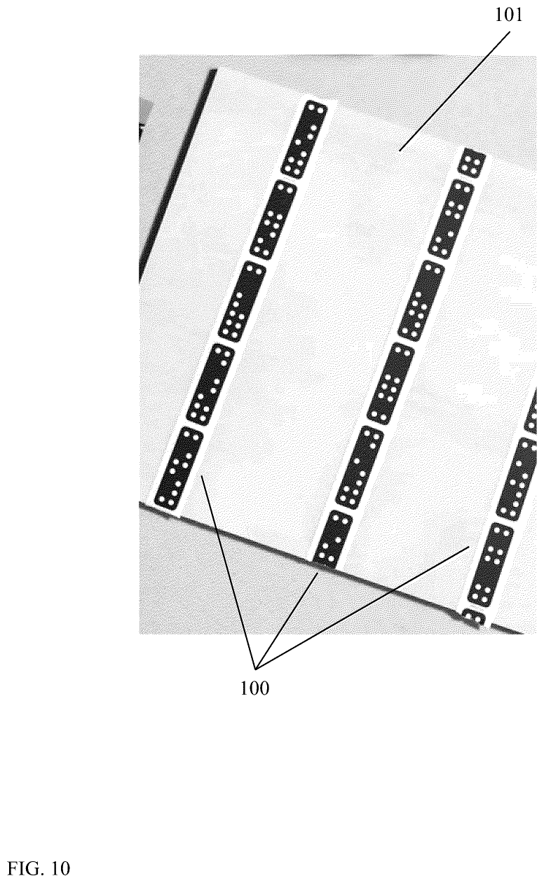

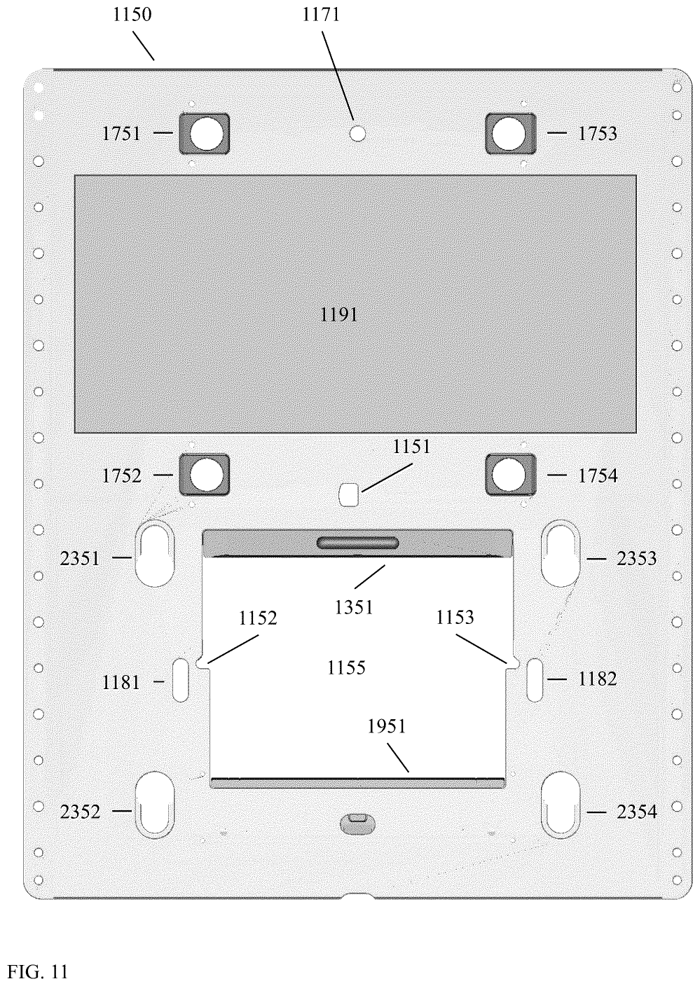

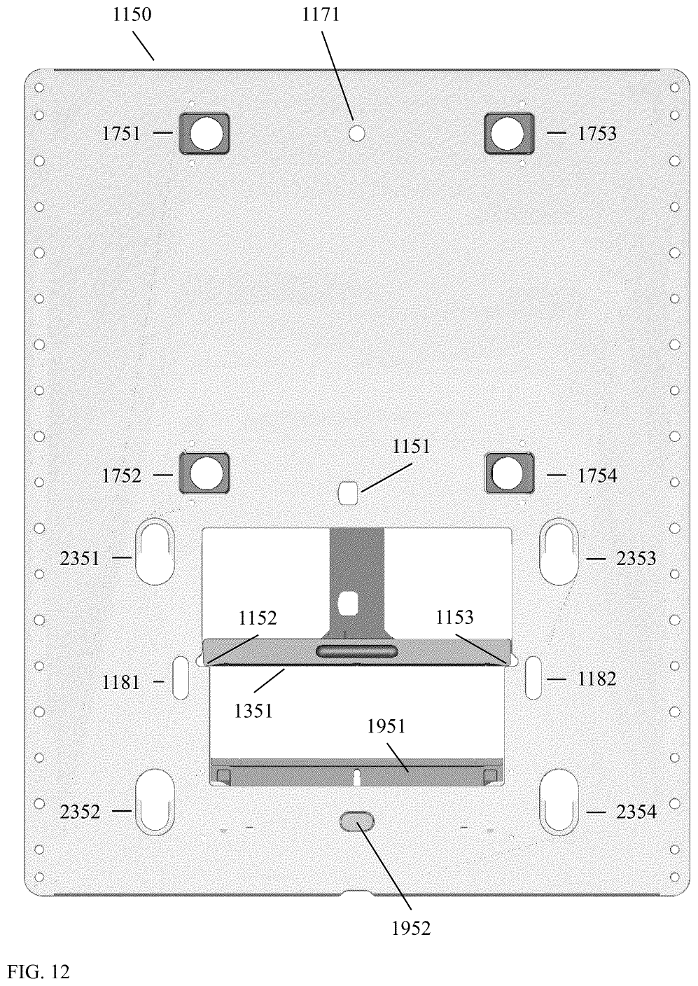

FIG. 11 illustrates a top view of an exemplary jig 1150. Jig 1150 may have a hole 1171 to allow the jig 1150 to be hung on a peg board for storage when not in use. In some embodiments, the jig 1150 may be 450 mm+/−10 mm tall and 362 mm+/−10 mm wide. Jig 1150 may have one or more flags (e.g., flags 1751-1754) permitting alignment to a workpiece edge—see description below. Jig 1150 may have one or more mechanical interfaces (e.g., keyholes 2351-2354) permitting a clamp head of a clamp to removably couple with the jig—see description below. Jig 1150 may have one or more datum points, e.g., datum points 1151 (right surface), 1152 (bottom surface), and 1153 (bottom surface). Jig 1150 may provide access to workpiece through region 1155—e.g., space not obstructed by the jig 1150, reticle 1351, or fence 1951. In some embodiments, region 1155 is roughly 160 mm (160 mm+/−10 mm) wide and roughly 120 mm (120 mm+/−10 mm) tall. Jig 1150 may have a retractable reticle 1351 permitting visual alignment to features on workpiece—see description below. Jig 1150 may have a retractable fence 1951 permitting mechanical alignment to a workpiece edge—see description below. Jig 1150 may have slots 1181 and 1182 providing reference position and pin positioning for System 32 style shelf pin hole machining. In some embodiments, the horizontal distance between slots 1181 and 1182 is a multiple of 32 mm. FIG. 12 illustrates a top view of jig 1150 with the reticle 1351 and fence 1951 in their extended states, respectively. In some embodiments, fence 1951 may have a button 1952 (e.g., in fence lock 1971, see below) to permit spring-loaded retraction of the fence 1951 from the deployed state when a user applies downward pressure on button 1952. In some embodiments, button 1952 may protrude past the top surface of jig 1150 such that if the base of an IBPS passes over the button 1952, the button 1952 is depressed (causing the fence 1951 to retract). This may prevent the cutting bit from damaging (e.g., cutting into) the fence 1951.

In some embodiments, one or more edges of jig 1150 may have holes (e.g., threaded or un-threaded) to allow other components to be attached to the jig. In some embodiments, a custom designed fence or rail may be attached to the jig using the provided holes to permit alignment to custom (e.g., curved-edge) workpieces. In some embodiments, leveling hardware (e.g., screws) may be used to support a portion of a jig that is not supported by a workpiece. For example, when a jig is placed on a workpiece with a corner of the workpiece positioned in the region (e.g., region 1155), one or more screws may be inserted in threaded holes at an edge of the jig and adjusted by a user to support portions of the jig that overhang the workpiece—for example, with a screw coupled to the jig and the bottom of the screw resting on the worksurface on which the workpiece rests. This allows the jig to support objects (e.g., weight of an IBPS) in scenarios in which the jig may be cantilevered otherwise. In some embodiments, the holes at the corners of the jig may be threaded to allow leveling hardware to be attached at the outer-most corners of the jig.

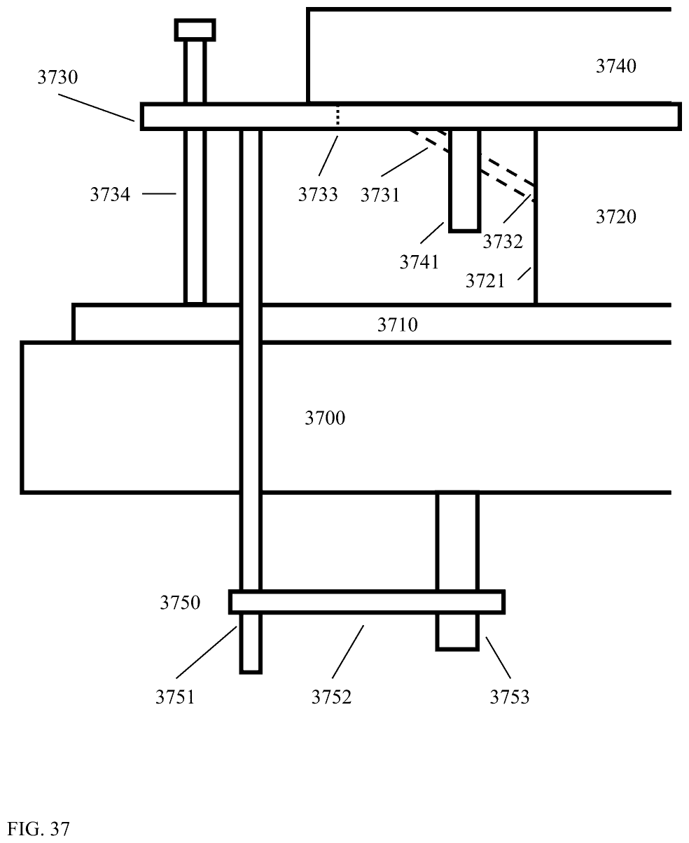

FIG. 37 shows a schematic side view of a workpiece 3720 set on top of an optional scrap piece 3710 which rests on workbench 3700. Scrap piece 3710 may be used to avoid cutting into the workbench 3700 if the task being performed on workpiece 3720 involves cutting through the full thickness of workpiece 3720. A portion of an exemplary jig 3730 rests on the top surface of workpiece 3720. Jig 3730 includes a region (opening) providing access to the workpiece through the jig 3730. The region includes (hidden) edge 3733 (dotted line). Jig 3730 may include an element 3731 (e.g., flag; dashed line) which permits mechanical alignment of jig 3730 to an edge 3721 of the workpiece 3720 when the element 3731 is in the deployed state (as shown). The jig 3730 may be mechanically aligned to the edge 3721 by bringing alignment surface 3732 (e.g., flag surface 1765, main fence surface 1963) of element 3731 into contact with the edge 3721 of the workpiece 3720.

Jig 3730 may include leveling hardware 3734 (e.g., an adjustable screw) to support a portion of the jig 3730 that is not supported by workpiece 3720. Abase 3740 of an exemplary IBPS (not fully shown) rests on the top of jig 3730. The exemplary IBPS includes component 3741 (e.g., cutting bit, probing bit) for performing a task on (e.g., cutting) or related to (e.g., probing an edge of) workpiece 3720. In some embodiments, element 3731 (e.g., fence 1951, one or more of flags 1751-1754) may protrude less than the thickness of workpiece 3720 from the bottom of jig 3730 so that the jig 3730 may be mechanically aligned to workpiece 3720 without interfering with scrap piece 3710 as illustrated in FIG. 37. In some embodiments, element 3721 (e.g., fence 1951, one or more of flags 1751-1754) may protrude less than 20 mm, 15 mm, 10 mm, 8 mm, 6 mm, 5 mm, or 4 mm relative to the bottom surface of jig 3730 over the transition from a retracted state to a deployed state or vice versa. In some embodiments, a clamp 3750, with clamp arm 3751, coupling bar 3752, and clamping mechanism 3753 (clamp head hidden, not shown), may be coupled to a mechanical interface of the jig 3730 to clamp the jig 3730 to the workbench 3700.

In some embodiments, jig 1150 is fabricated from Aluminum. In some embodiments, jig 1150 is 20 mm, 15 mm, 10 mm, 8 mm, 6 mm, 5 mm, 4 mm or less thick. In some embodiments, to provide a smooth surface for the base of the IBPS to slide across, the top surface of jig 1150 is planar over more than 50%, 60%, 70%, 80%, or 90% of its top planar surface area. In some embodiments, features (e.g., features 1100, fiducial markers with encoded patterns, dominos) for IBPS position detection are included in box indicated by 1191. In some embodiments, features are cut into jig 1150, applied to jig 1150 as one or more stickers or adhesive tape, painted on jig 1150, or stencil cut on a separate sheet/film and attached to jig 1150. In some embodiments, one or more adhesive films (e.g., film with features (e.g., features 1100, fiducial markers with encoded patterns, dominos)) are applied to planar potions of jig 1150.

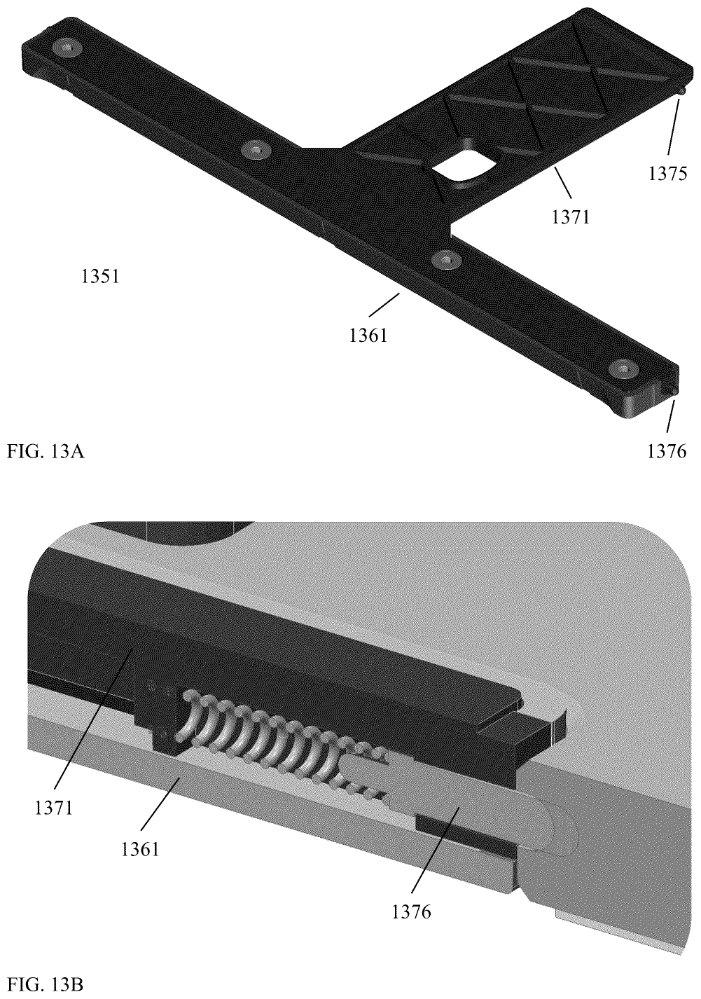

FIG. 13A shows a view of the bottom part of an exemplary reticle 1351 including reticle carrier 1371 and reticle surface 1361. Reticle carrier 1371 has two back pins to guide the back portion of the reticle carrier 1371 in the jig 1150—reticle carrier 1371 back pin 1375 is shown (other back pin is not visible in the view shown in FIG. 13A). Reticle carrier 1371 has two front spring-loaded plungers that keep the reticle 1351 biased against datum surfaces in the jig 1150 (e.g., based on ramp 1481 design, see below)—reticle carrier 1371 front pin 1376 is shown (other front pin is not visible in the view shown in FIG. 13A); see detail view in FIG. 13B. The front spring-loaded plungers and the two back pins keep the reticle 1351 constrained to move within the tracks in jig 1150. The two spring-loaded plungers allow the reticle 1351 to be removed from the tracks in jig 1150 by retracting a plunger to be flush with reticle surface 1361. Reticle cover 1361 is screwed into place over the front of reticle carrier 1371. FIG. 13B shows cross section view of reticle carrier 1371, reticle cover 1361, and front pin 1376. In some embodiments, reticle carrier 1371 is fabricated from Delrin or glass-filled Nylon. In some embodiments, reticle cover 1371 is fabricated from steel (e.g., steel 316L).

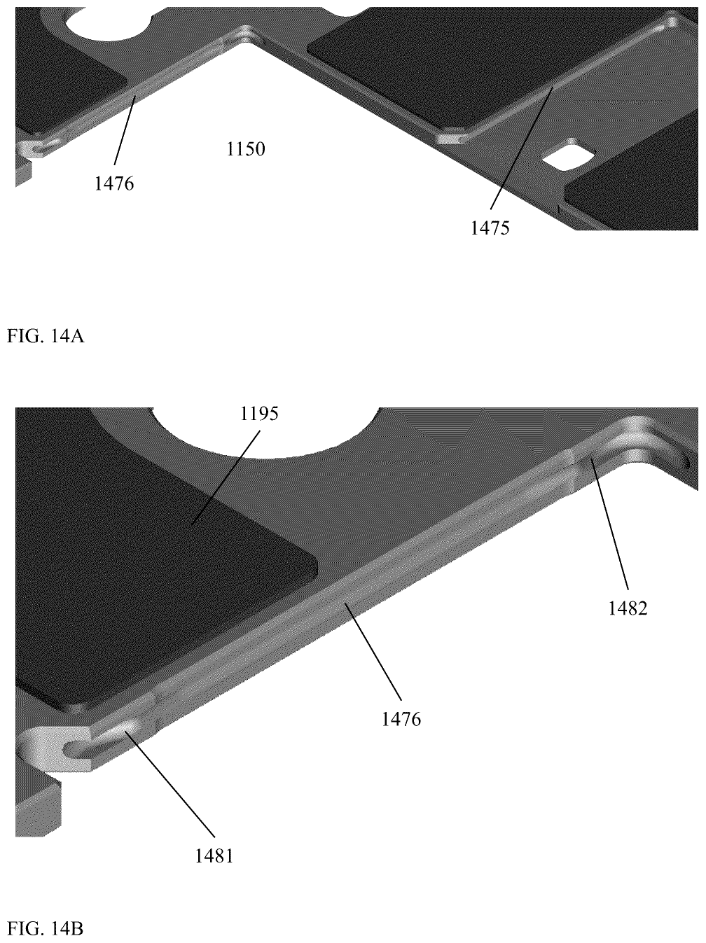

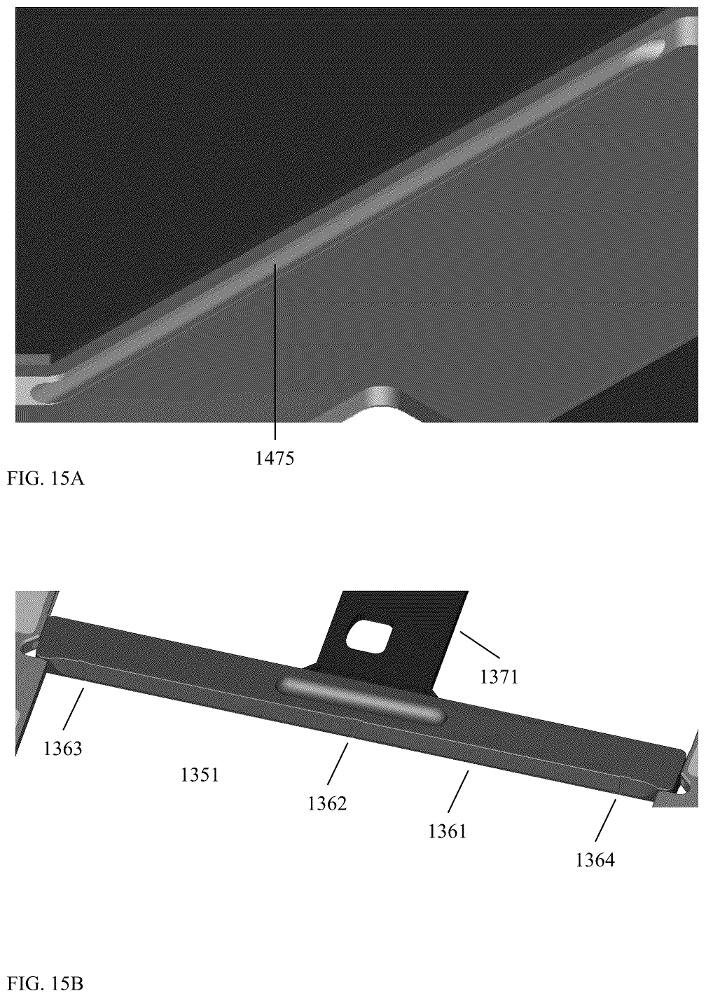

FIG. 14A shows a view of a bottom part of an exemplary jig 1150. Jig 1150 includes back pin track 1475 and front pin track 1476. FIG. 14B shows a close-up view of front pin track 1476. Front pin track 1476 is designed with a ramp at the front end 1481 (near datum point 1153) and a ramp at the back end 1482 (near retracted reticle position). The ramped feature in front pin track 1476 provides spring loaded action (based on the spring-loaded plunger) to keep the reticle cover 1361: (1) flush against datum point 1153 surface in the deployed state (via ramp 1481) and (2) latched in the retracted state (via ramp 1482). In some embodiments, the bottom of jig 1150 is covered with one or more rubber backing portions 1195 (e.g., to passively hold plate on work surface based on higher friction (as IBPS moves on top surface of jig 1150), to protect the workpiece from scratches/wear). FIG. 15A shows back pin track 1475.

FIG. 15B shows reticle 1351 with reticle cover 1361 and reticle carrier 1371 in deployed state with the two ends of reticle cover 1361 in contact with datum points 1152 and 1153. In some embodiments, datum points 1152 and 1153 may be selected such that reticle cover 1361 in the deployed state is centered in the region 1155 (centered in the vertical direction in FIG. 12). Reticle cover 1361 includes fiducial marks 1362 (marking the center of the reticle cover; aligned with datum point 1151), 1363 (aligning with flags 1751 and 1752), and 1364 (aligning with flags 1753 and 1754). The fiducial marks 1362, 1363, and 1364 allow a user to align the jig to fiducial marks on the workpiece. FIG. 16 shows the top view of reticle cover 1361 in the deployed state with the front surface of the reticle cover 1361 in contact with datum point 1152. The back edge (in this view) of the reticle cover 1361 (marked B) and the leading edge of the plate (marked A) are shaped to bring the reticle cover 1361 into tighter mechanical tolerance to improve the horizontal accuracy of fiducial marks 1362, 1363 (shown), and 1364. The flat portion of jig 1150 just above box 1650 may be a datum surface for probing datum point 1152—other datum points (e.g., 1151 and 1153) may have similar datum surfaces, respectively.

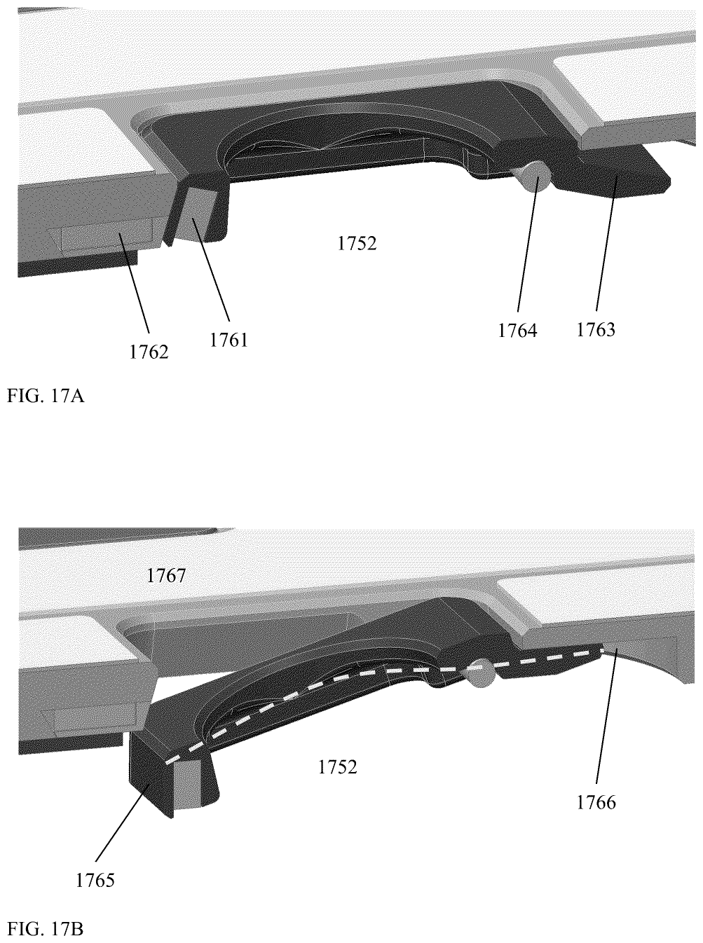

FIG. 17A shows a cross section view of flag 1752 in the recessed state. Other flags (1751, 1753, and 1754) may share the same design as flag 1752. FIG. 17B shows a cross section view of flag 1752 in the deployed state. In the recessed state, the magnetic attraction between magnets 1761 (press fit into flag 1752) and 1762 (press fit into jig 1150) keep the flag in the recessed state. In the deployed state, the magnetic repulsion between magnets 1761 and 1762 keep the flag in the deployed state. The flag 1752 is hinged to rotate about pin 1764, and the angle of surface 1763 is designed to contact surface 1766 of jig 1150 so that flag surface 1765 is perpendicular to jig 1150 top surface 1767 in the deployed state. In the deployed stage, flag 1752 may be aligned against an edge of a workpiece by abutting flag surface 1765 against a surface on the edge of the workpiece. Flags 1751 and 1752 have hinges on the left side (as depicted in FIGS. 11 and 12); when deployed, the right side of flags 1751 and 1752 move into the plane depicted in FIGS. 11 and 12. Flags 1751 and 1752 may be used together to align to a first edge of a workpiece. Flags 1753 and 1754 have hinges on the right side (as depicted in FIGS. 11 and 12); when deployed, the left side of flags 1753 and 1754 move into the plane depicted in FIGS. 11 and 12. Flags 1753 and 1754 may be used together to align to a second edge of a workpiece. In some embodiments, flag 1752 or pin 1764 is made from steel (e.g., steel 316L).

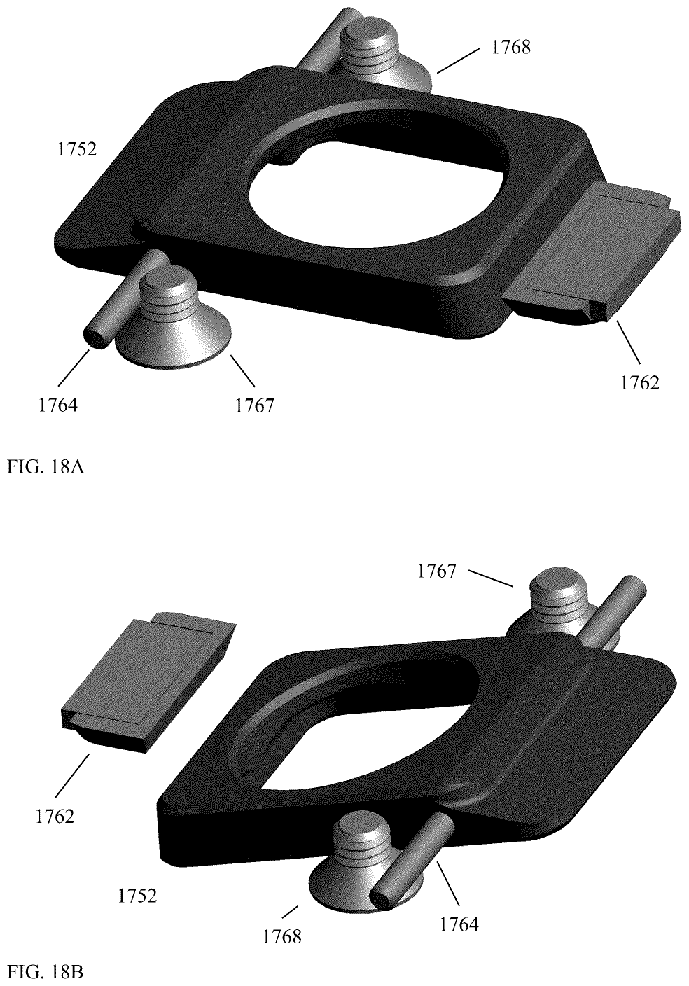

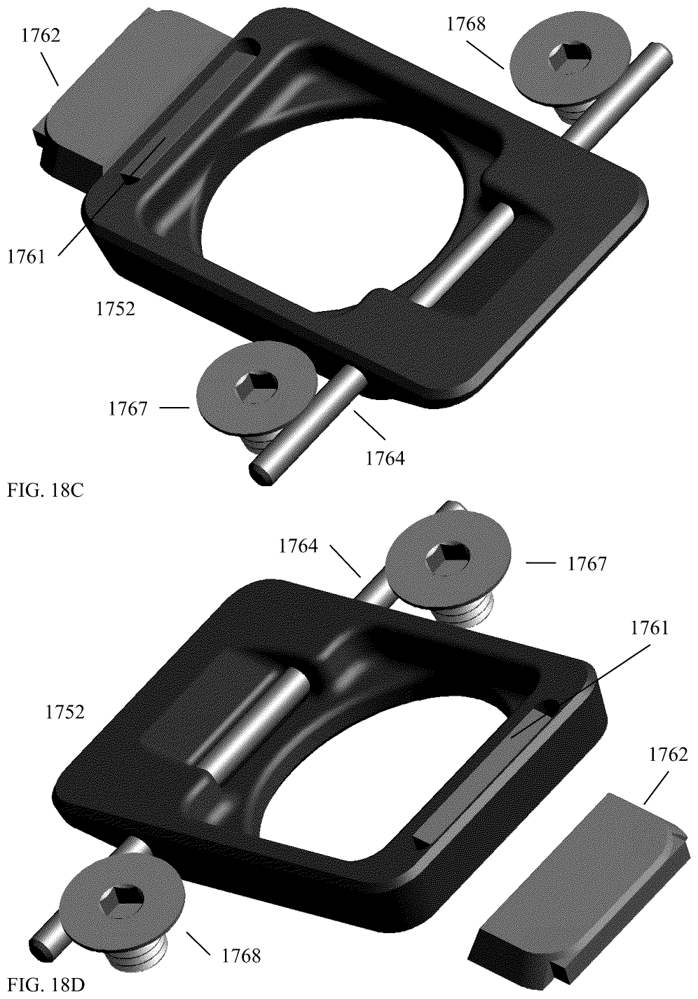

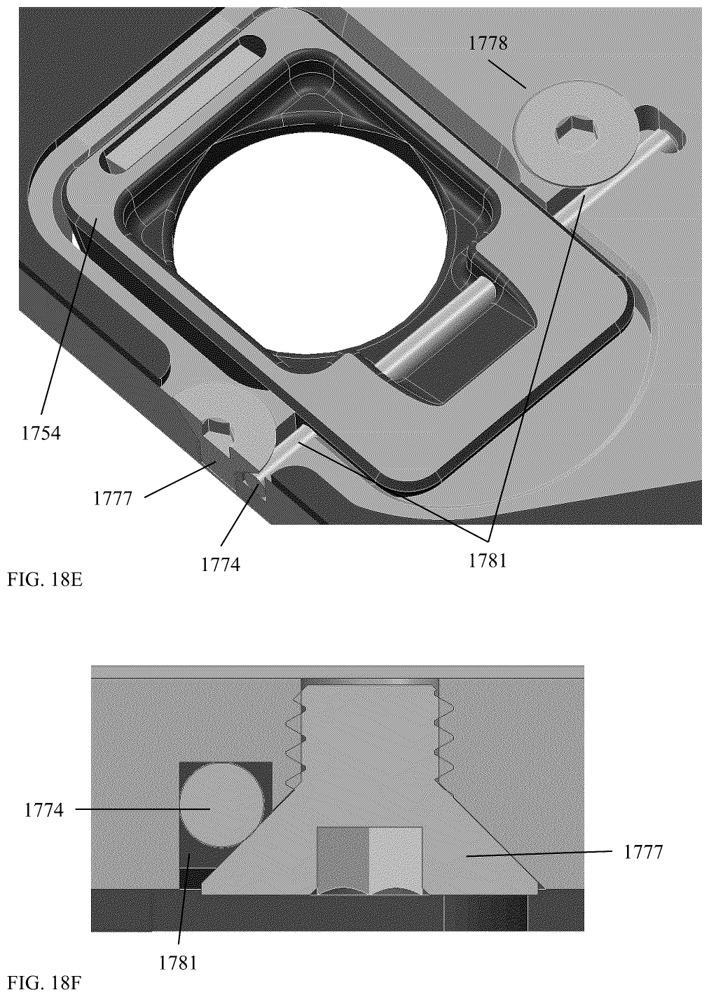

FIG. 18A shows a top view of flag 1752 in the retracted state. Flag 1752 is secured to jig 1150 using pin 1764 and two screws 1767 and 1768. FIG. 18B shows a top view of flag 1752 in the deployed state. FIG. 18C shows a bottom view of flag 1752 in the retracted state. FIG. 18D shows a bottom view of flag 1752 in the deployed state. FIG. 18E shows a bottom cross-section view of flag 1754 in the retracted state. Flag 1754 is secured to jig 1150 using pin 1774 and two screws 1777 and 1778. Pin 1774 is positioned in a trench 1781 cut into jig 1150. FIG. 18F shows a side cross-section view of screw 1777 showing the position of pin 1774 relative to trench 1781. The position of flag 1754 in the plane of jig 1750 perpendicular to long axis of pin 1774 is determined by the positions of the top and left side of trench 1781 in FIG. 18F and the diameter of pin 1774. The deployed position the flag surface for flag 1754 (e.g., relative to one or more datum points; see corresponding flag surface 1765 for flag 1752) may be tightly controlled by controlling: the tolerance for cutting the trench 1781, controlling the tolerance of the diameter of pin 1774, controlling the diameter of hole in flag 1754 for pin 1774, and controlling the contacting surfaces between flag 1754 and jig 1150 (see corresponding surfaces 1763 and 1766 for flag 1752, respectively) in the deployed state.

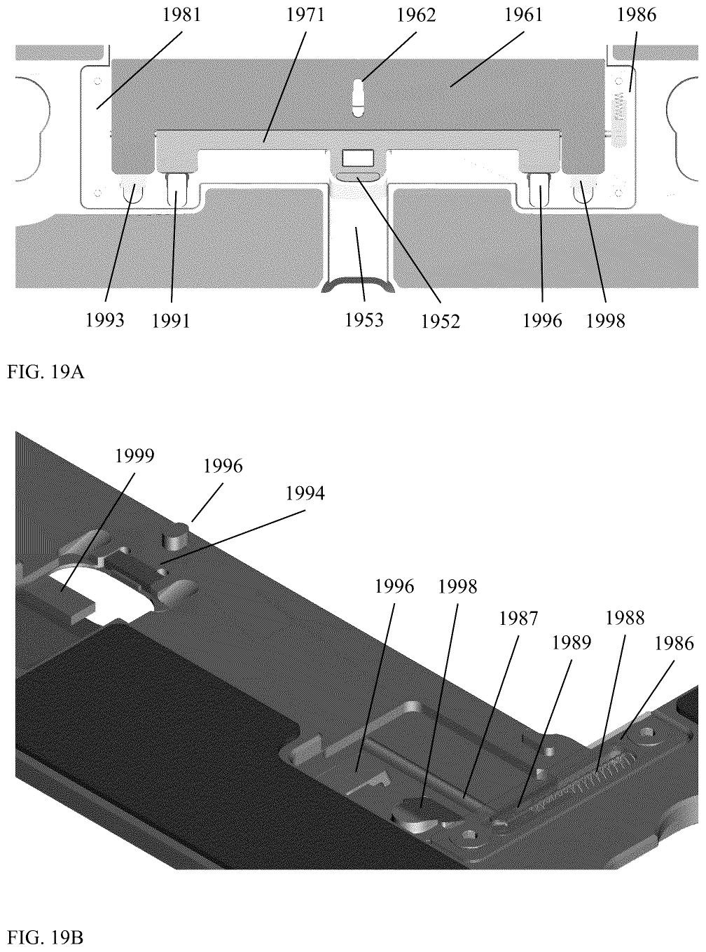

FIG. 19A shows the bottom view of jig 1150 with an exemplary fence 1951 in the deployed state. Fence 1951 includes main fence 1961, fence lock 1971, and right 1981 and left 1986 spring mechanisms (note, positions of spring mechanisms are reversed in the bottom view). Main fence 1961 includes a fence guide slot 1962. In the deployed state, the springs in the right 1981 and left 1986 spring mechanisms are compressed; the compression in the springs causes the fence 1951 to retract when the fence lock 1971 is pushed by the user. The deployed position of the fence 1951 is set by right 1991 and left 1996 fence stops. The right 1993 and left 1998 fence ramps guide the motion of the main fence 1961 between the retracted and deployed state. In some embodiments, fence lock 1971 may include a deployment tab 1952 for a user to engage when deploying the fence. In some embodiments, jig 1150 may include a cut out 1953 to guide the user's fingers to the deployment tab 1952. In some embodiments, main fence 1961, fence lock 1971, or pin 1987 (is below) is made from steel (e.g., steel 316L). In some embodiments, the fence stop or fence ramp is fabricated from Delrin or glass-filled Nylon.

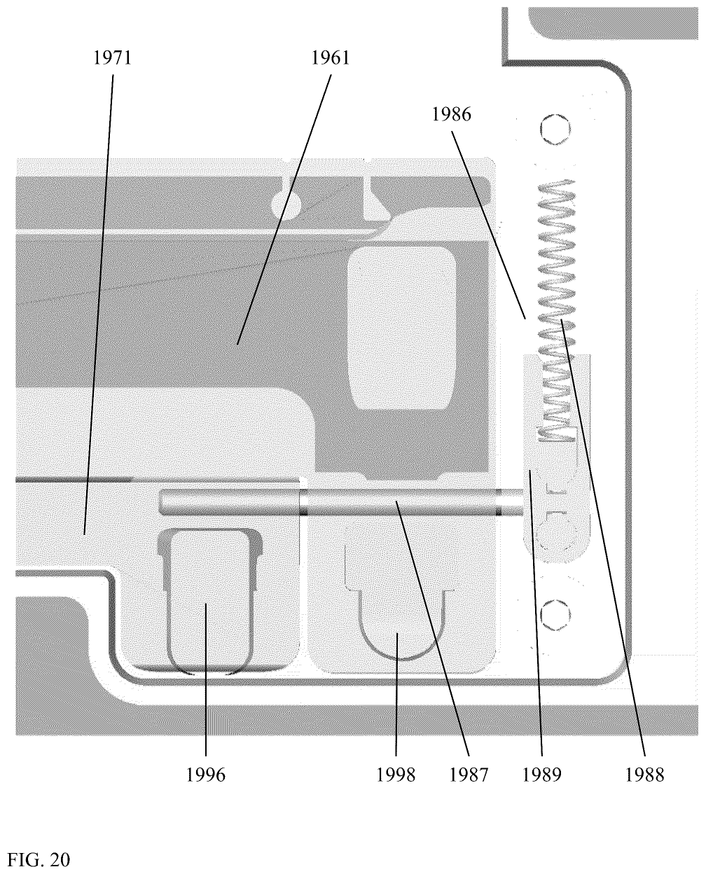

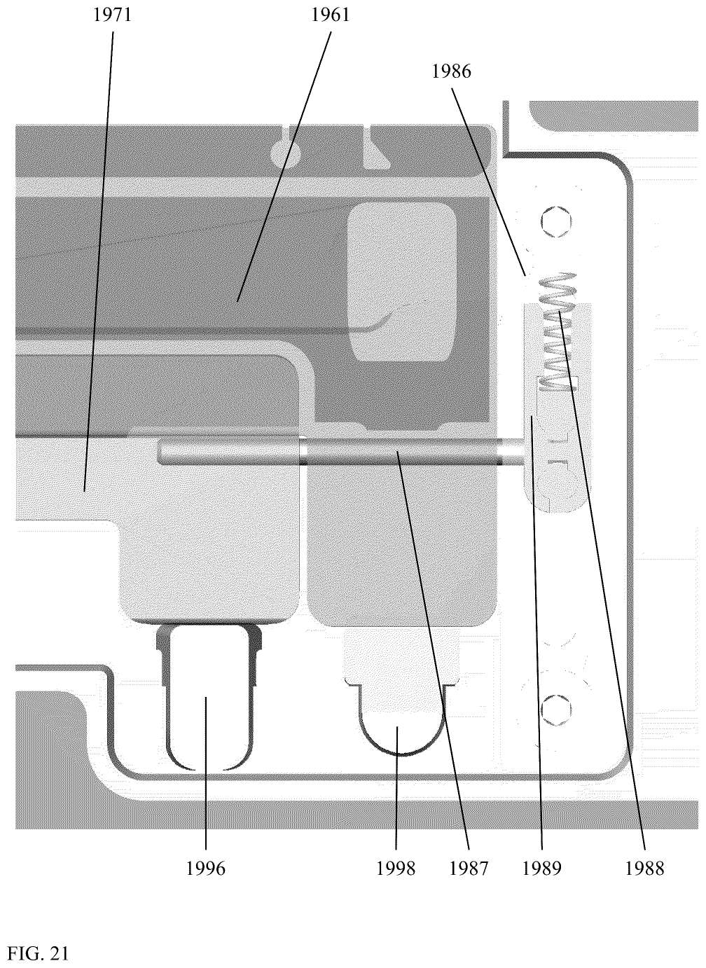

FIG. 19B shows a view of the bottom of jig 1150 with the main fence 1961 and fence lock 1971 both hidden from view (with the fence 1951 in the retracted state). Left spring mechanism 1986, mounted to jig 1150, includes a pin 1987 that is coupled to a spring 1988 via a carrier 1989. Main fence 1961 and fence lock 1971 are coupled to right (not shown) and left 1987 pins in the right (not shown) and left 1986 spring mechanisms. In some embodiments, left fence stop 1996 or left fence ramp 1988 may be replaceable (e.g., if worn from usage). Jig 1150 includes fence guide pin 1964. One or more magnets (e.g., 1994, 1999) may be coupled to the jig 1150 or fence 1951 components to keep the fence 1951 in the deployed or retracted state—for example, magnets 1994 and 1999 help position the fence button 1952 relative to the top surface of jig 1150. FIG. 20 shows the top-down view of the bottom of jig 1150 with the main fence 1961 and fence lock 1971 shown in transparent mode (with the fence 1951 in the retracted state). FIG. 21 shows the top-down view of the bottom of jig 1150 with the main fence 1961 and fence lock 1971 shown in transparent mode (with the fence 1951 in the deployed state). In some embodiments, the carrier may include components made from PTFE, Derlin or glass-filled Nylon.

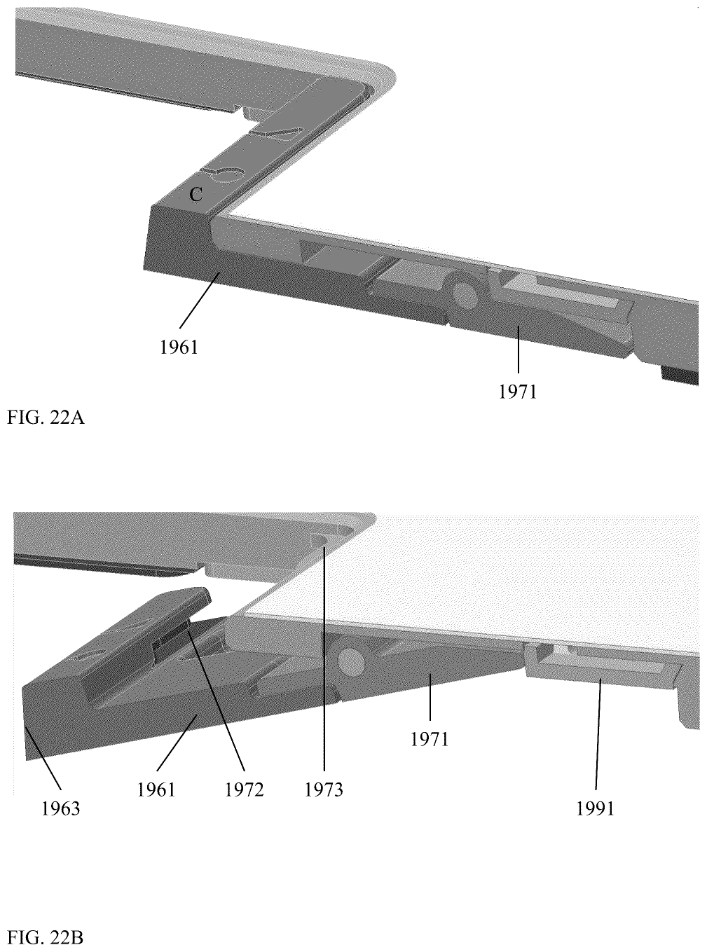

FIG. 22A shows the fence 1951 in the retracted state with main fence 1961 and fence lock 1971 moved back such that they are planar and recessed in jig 1150. FIG. 22B shows the fence 1951 in the deployed state with main fence 1961 and fence lock 1971 moved forward such that main fence surface 1963 may be aligned to an edge of a workpiece. Mechanical tolerancing and design of right 1991 and left (not shown) fence stops, main fence 1961, and fence lock 1971 ensure that the main fence surface 1963 is perpendicular to jig 1150 top surface. Forces applied to main fence surface 1963 bias the fence 1951 against the jig via main fence 1961, fence lock 1971, and right 1991 and left (not shown) fence stops resulting in highly repeatable positioning.

Tightly controlled mechanical tolerancing of these components ensures highly accurate positioning of the main fence surface 1963 with the fence 1951 in the deployed state (e.g., relative to datum points 1152 and 1153). In some embodiments, fence 1951 may retract from a deployed state to a retracted state without mechanically interfering with a workpiece to which the fence 1951 is aligned (e.g., not moving forward into the workpiece during the retraction process) so that the alignment between the workpiece and the jig 1150 is maintained after the fence 1951 has retracted. This may be required to maintain alignment between the workpiece and the jig 1150 in configurations in which a workpiece edge is to remain in region 1150 (e.g., to permit cuts that go over the workpiece edge).

In some embodiments, if a jig 1150 element (e.g., fence 1951, flag 1751-1754) position accuracy in the deployed state (e.g., relative to datum points 1151, 1152, or 1153) departs from a design target or changes over time, the shift in the jig element deployed state position may be captured in the jig design information. A position of a digital design referenced to the jig element deployed state position may be shifted to account for the change in jig element deployed state position. In some embodiments, an IBPS may be used to measure the jig element position in the deployed state (relative to datum points) to determine if a shift in the jig element position is present (relative to corresponding data in the jig design information). In some embodiments, if a shift in the jig element position is detected, the jig design information may be updated to include the shift information for the jig element.

In some embodiments, main fence 1961 may have one or more cut outs 1972 and jig 1150 may have corresponding tabs 1973 as indicated in FIG. 22B such that, in the retracted state, a force applied on main fence 1961 surface identified as C in FIG. 22A does not cause the fence 1951 to lift away (“down” in FIG. 22A) from the jig 1150. For example, cut out and tab similar to cut out 1972 and tab 1973 may be present on the left side of the main fence 1961 and jig 1150.

In some embodiments, a clamp selected from one of various designs may be removably coupled to a jig having a matching mechanical interface (e.g., keyhole interface) for attaching the clamp. For example, a clamp may be attached to a jig, allowing the jig to be clamped to other parts (e.g., table) without increasing the thickness of the jig and with no elements of the clamp protruding above the top surface of the jig. Maintaining a planar surface for the top of the jig in a clamped state allows a base of an IBPS to move over the jig without mechanical interference from components of the clamp. In some embodiments, the thickness of the jig may prevent usage of clamps that mate to T-slots; T-slots are an existing solution for clamping to thick plates.

A jig may have features such as a mechanical interface (e.g., keyhole interface) to work with a clamp. The mechanical interface provides support for coupling of a clamp head. The keyhole clamp interface, if used, is an improvement compared to a traditional T-slot because where a T-slot only supports the corresponding T-nut on two sides, when fully engaged; the keyhole supports the clamp head on three sides.

The material of the jig must be strong enough to support the tensile and torsional loads produced by the clamp. In some cases, much more material supports the keyhole compared to the clamp head, so to design for equal strength of the parts the keyhole may be made with less material (in thickness) or weaker material compared to the clamp head. For example, for equal thickness clamp head and keyhole sections, if the clamp head is made of hardened steel, the keyhole may be mild steel. If the clamp head is mild steel, the keyhole may be aluminum.

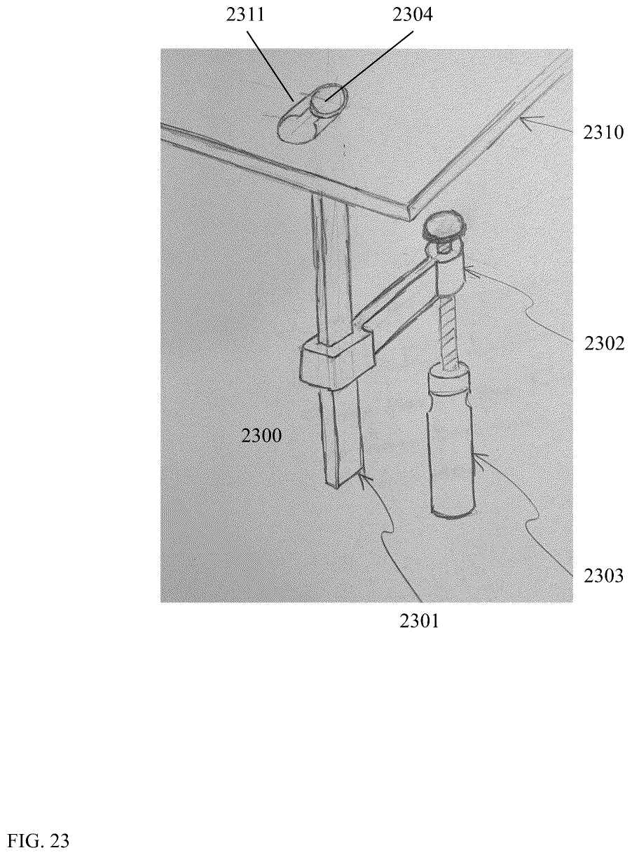

FIG. 23 illustrates a view of an exemplary clamp 2300 removably coupled to a jig 2310. Jig 2310 includes keyhole 2311. Clamp 2300 is coupled to jig 2310 via keyhole 2311. Clamp 2300 includes clamp arm 2301, coupling bar 2301, clamping mechanism 2302, and clamp head 2303.

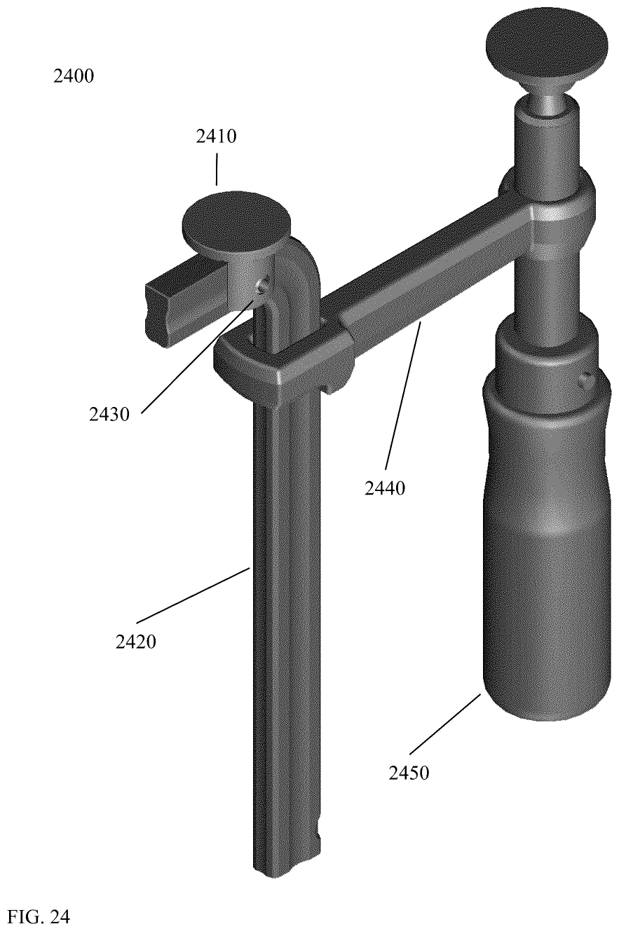

FIG. 24 shows an exemplary clamp 2400 including clamp head 2410 coupled to a clamp bar 2420 using pin 2430. A portion of a keyhole engages with the bottom portion of clamp head 2410 that is positioned above the keyhole, and a portion of keyhole (e.g., jig bottom) engages with the top, flat portion of clamp arm 2420. A coupling bar 2440 couples the clamp bar 2420 to a clamping mechanism 2450. Clamp 2400 is coupled to the jig by inserting the clamp head 2410 into the wider opening section of keyhole from underneath the jig and sliding the clamp head 2410 into the narrower opening section of keyhole. After coupling the clamp head 2410 to the jig, the jig may be clamped to a worksurface or a workpiece by using the clamping mechanism 2450 (e.g., turning the handle on a threaded clamping mechanism 2450, for example, see FIG. 30, to engage the clamping mechanism with the worksurface or workpiece).

In some embodiments, a damaged or worn clamp head 2410 may be replaced by removing pin 2430, sliding the old clamp head off of the short arm of clamp bar 2420, sliding a new clamp head on to the short arm of the clamp bar 2420, aligning the new clamp head with a through hole in the short arm of the clamp bar 2420, and reinserting (new) pin 2430 to secure the clamp head to the clamp bar 2420. In some embodiments, the clamp head 2410 may be coupled to the clamp bar 2420 using a fastener (e.g., nut and bolt, set screw, or the like). In some embodiments, the clamp head and the clamp bar may be one single piece—e.g., machined from a single block of material, cast as a single piece, or soldered or welded together. In some embodiments, coupling bar 2440 may be free to move along the long axis of the clamp bar 2420 to accommodate different geometries for clamping the jig 1150 to a worksurface or workpiece on which the jig 1150 is resting. In some embodiments, the coupling bar 2440 and clamping mechanism 2450 may be decoupled from clamp bar 2420 (e.g., by sliding the coupling bar 2440 down the long axis of the clamp bar 2420).

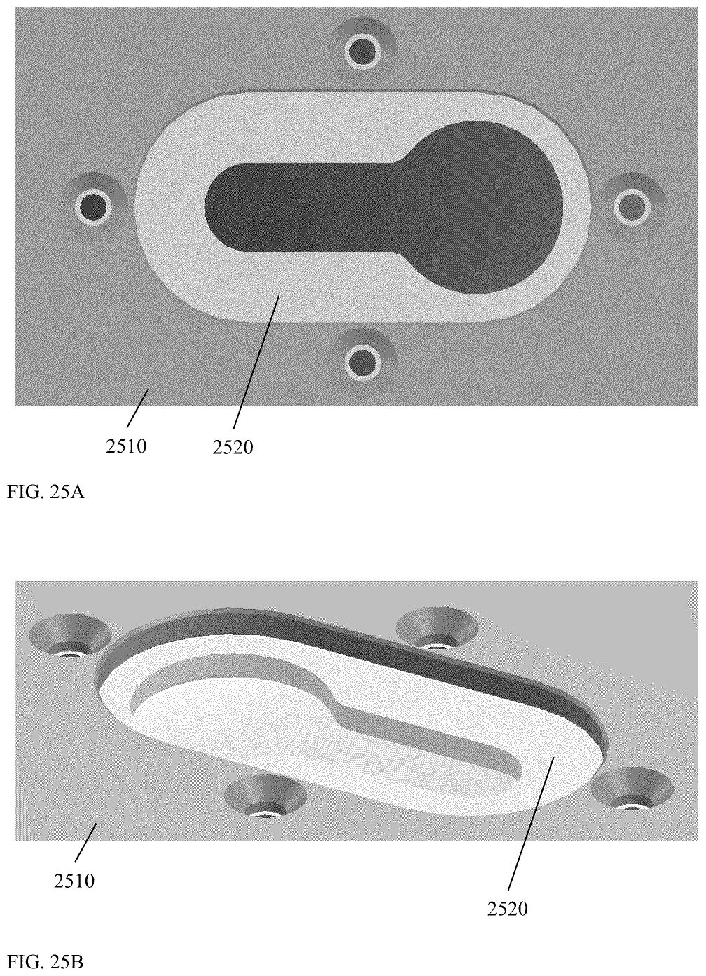

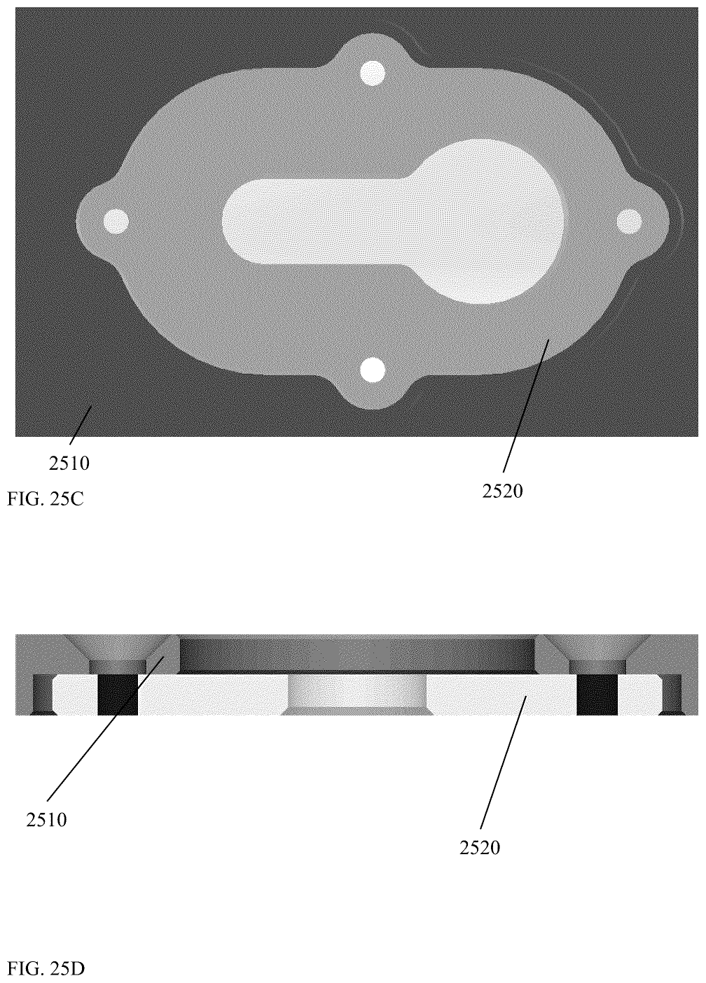

If the jig must be made of material which is incompatible with a mechanical interface, an insert may be added which provides the required material and mechanical properties at the mechanical interface. FIG. 25A shows a top view of an exemplary jig mechanical interface for a clamp; an insert 2520 made from an appropriate material is attached from the bottom to screw holes on the top of the jig 2510. FIG. 25B shows a view of the insert 2520 and the mechanical interface region of the jig 2510. FIG. 25C shows the bottom view of the jig 2510 showing the shape of the insert 2520. FIG. 25D shows a cross section view of the insert 2520 (bottom) and the jig 2510 (top).

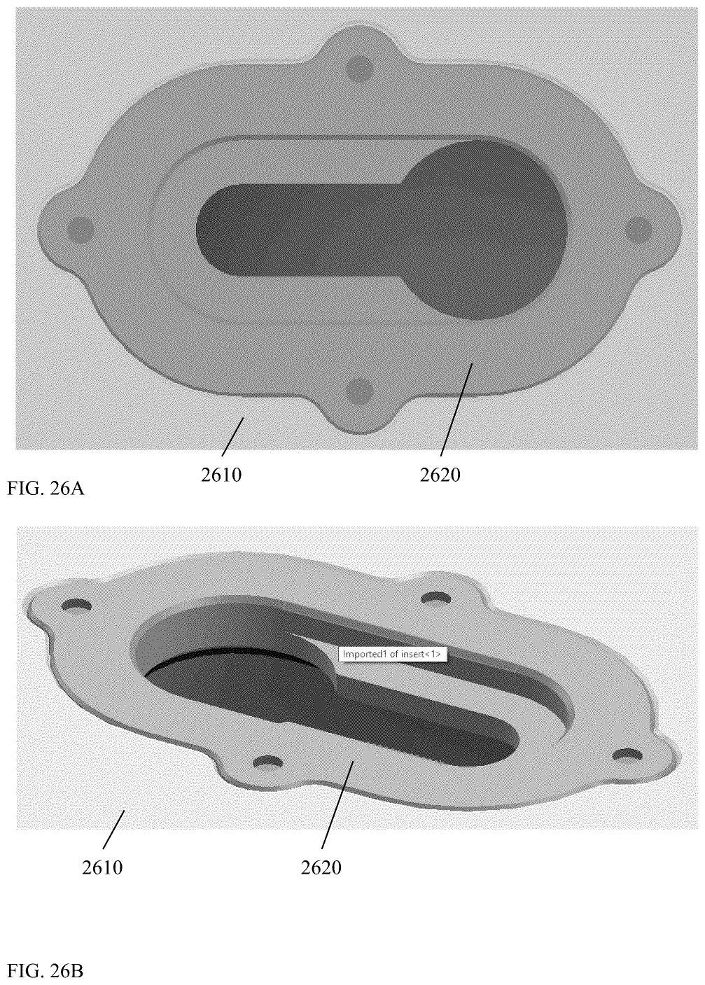

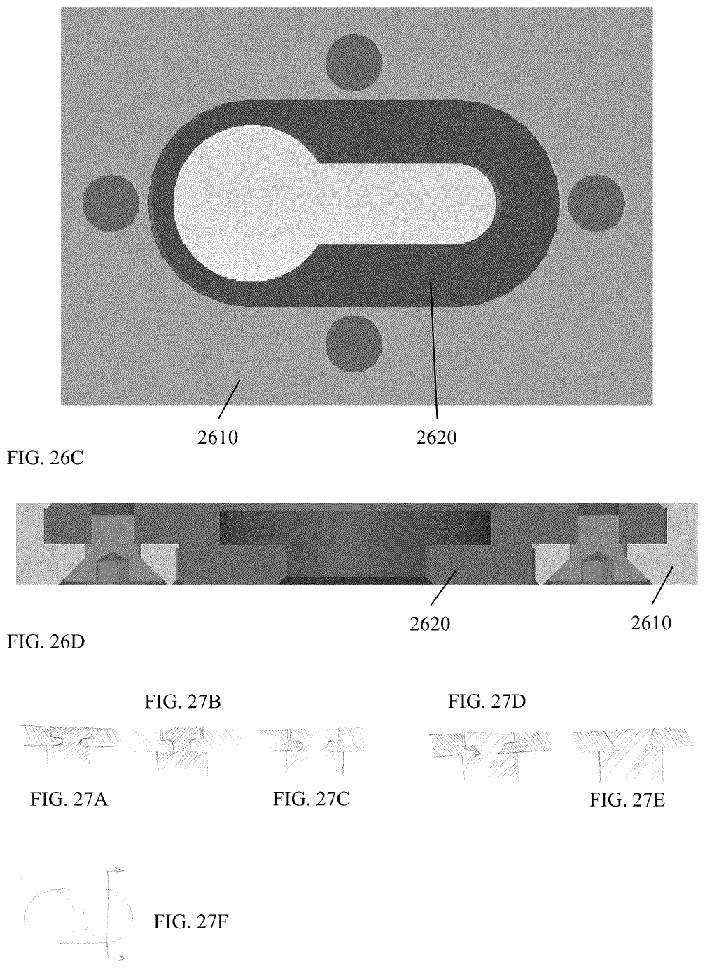

FIG. 26A shows a top view of another exemplary jig mechanical interface for a clamp; an insert 2620 made from an appropriate material is attached on top of the jig 2610 using screw holes on the bottom of the jig 2610. FIG. 26B shows a view of the insert 2620 and the mechanical interface region of the jig 2610. FIG. 26C shows a bottom view of the jig 2610 showing the shape of the insert 2620. FIG. 26D shows a cross section view of the insert 2620 (top) and the jig 2610 (bottom). In some embodiments, insert 2620 may be designed to permit attachment of the insert 2620 to the bottom of the jig using screw holes on the top of the jig.

FIGS. 27A-E show various keyhole (outer area) and clamp head (middle area) cross-section geometries (see 27F diagram). Some of the illustrated geometries may include rounded or tapered sections to reduce stress on the clamp head or the keyhole.

In some embodiments, the keyhole may also include features to keep the clamp head (and clamp bar) in place within the keyhole. One such feature is a shallow depression in the keyhole which the clamp head drops into when inserted fully. Another such feature is a ball plunger in the side of the keyhole, placed such that the widest point of the clamp head snaps past the plunger during insertion in the keyhole.

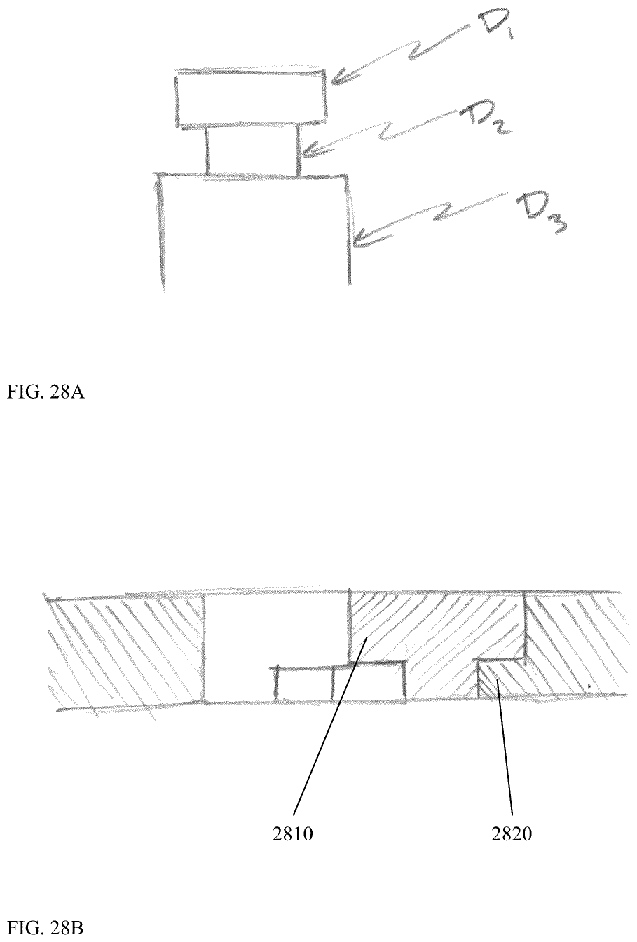

FIG. 28A shows a cross-section of an exemplary clamp head and clamp bar design. Clamp head may utilize a design such that diameters D1, D2, and D3 satisfy D3>D1>D2. In this arrangement, D3>D1 provides a positive stop against the open end of a keyhole, affording easy alignment of the clamp head with the keyhole. D1>D2 holds the clamp head in the keyhole. Increasing D2 reduces the torsional load on the clamp head. This clamp head geometry is referred to as “a button head.” FIG. 28B shows an exemplary clamp head and keyhole design such that the clamp head thickness (2810; “D1” section in FIG. 28A) is thicker than the keyhole interface 2820 on the jig. In some embodiments, the clamp head diameter D1 is 20 mm, and the clamp head thickness of the D1 portion is 2.3 mm (corresponding to 2810). In some embodiments, the thickness of the jig inside the keyhole is 2.3 mm (corresponding to 2820).

In some embodiments, the clamp head interface is the weakest link in the clamp. To mitigate clamp failures in such instances, other elements of the clamp may introduce elements which limit the load on the clamp head interface. The clamp bar has several opportunities for such load limiting. One is a sprung attachment to the clamp head which limits strain on the clamp head—before strain reaches failure-inducing levels, the spring attaching the clamp bar to the clamp head lengthens. Another opportunity for load limiting in the clamp bar is a feature which allows the clamp bar to bend before the failure point of the clamp head interface is reached. In some instances, the clamp head may be made of a stronger material than the jig mechanical interface (e.g., keyhole).

An axially-symmetric clamp head design allows the clamp to rotate freely 360 degrees (e.g., about an axis parallel to the long-axis of the clamp bar) when inserted into the mechanical interface on a jig. In contrast, existing T-slot clamps typically have fixed orientation or limited range of motion. If desired, a non-circular head design, for example, either at D1 or D2 (in FIG. 28A), may be used to prevent rotation of the clamp in the keyhole.

For ease of manufacturing and cost reduction, the clamp head may be manufactured separately and then fastened to the clamp bar with screws, rivets, pins, crimping, welding, brazing, or adhesives. Additionally or alternatively, the clamp head may be assembled, for example, using a screw (for D1) and washer (for D2) with the screw screwing into a threaded clamp bar (for D3), to form the clamp head and clamp bar piece.

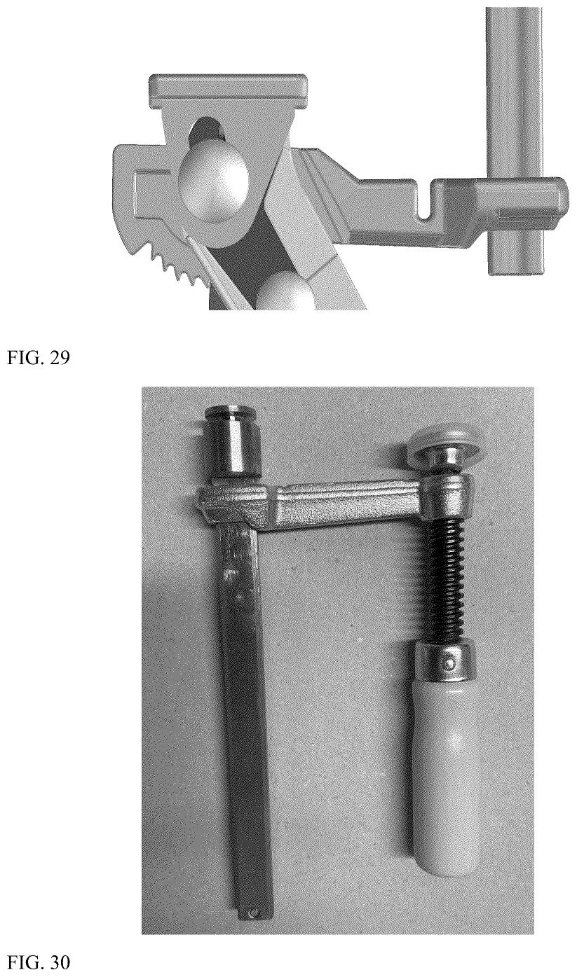

The coupling bar works very similarly to the coupling bar on existing bar-style clamps. The improvement here is a load limiting feature which limits the loads on the clamp head/mechanical interface. One such feature is a cutout to make the perpendicular bar more flexible (see FIG. 29).

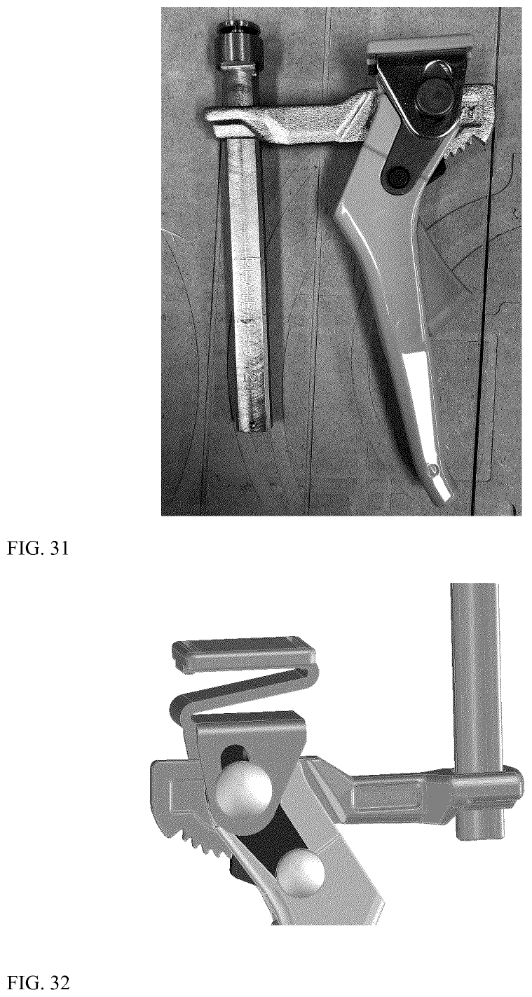

The clamp mechanism applies load to the parts being clamped, including the clamp, jig (e.g., plate) and the clamp/jig interface. Thus, the clamp mechanism has several opportunities for improvement in the context of controlling the load at the clamp head and jig mechanical interface. These improvements are based on two existing clamp designs—a screw clamp (see FIG. 30) and a ratcheting lever clamp (see FIG. 31).

Improvements to the screw clamp also limit the load on the button clamp head/keyhole. To limit the torque transmitted from the handle to the screw, a mechanism that slips at a preset torque may be added (e.g., as implemented in a torque limiting screwdriver, torque wrench, or the like).

Improvements to the ratcheting lever clamp limit the load applied given the limited travel of the ratcheting lever. One solution is a sprung clamp pad (see FIG. 32) which applies the correct load when compressed the distance of a full lever pull. Another solution is limited lever travel corresponding to the overall stiffness of the clamp and the appropriate load corresponding to a specific amount of elastic deformation in the clamp as a whole.

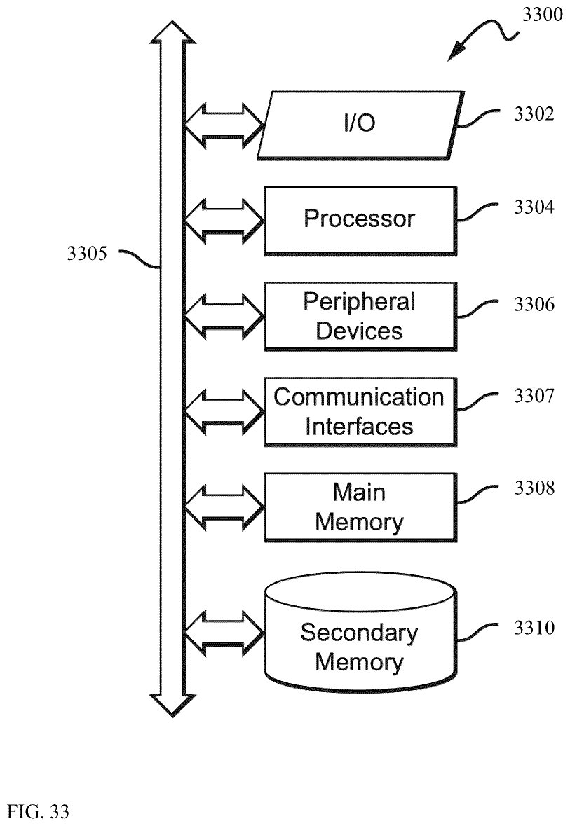

FIG. 33 illustrates an example of a computer system 3300 that may be used to execute program code stored in a non-transitory computer readable medium (e.g., memory) in accordance with embodiments of the disclosure. The computer system includes an input/output subsystem 3302, which may be used to interface with human users or other computer systems depending upon the application. The I/O subsystem 3302 may include, e.g., a keyboard, mouse, graphical user interface, touchscreen, or other interfaces for input, and, e.g., an LED or other flat screen display, or other interfaces for output, including application program interfaces (APIs). The I/O subsystem 3302 may include one or more components to receive output from one or more cameras, a load cell amplifier or other sensor measurement system coupled to sensors for detecting the input from the user to control the positioning system. The one or more components may include data acquisition electronics to read the sensor output, load cell amplifier output, or the sensor measurement system output. The I/O subsystem 3302 may include one or more components to provide output to one or more actuators (e.g., stepper motor) or to one or more actuator controllers.

Program code may be stored in non-transitory computer-readable media such as persistent storage in secondary memory 3310 or main memory 3308 or both. Main memory 3308 may include volatile memory such as random access memory (RAM) or non-volatile memory such as read only memory (ROM), as well as different levels of cache memory for faster access to instructions and data. Secondary memory 3310 may include persistent storage such as solid state drives, hard disk drives or optical disks. One or more processors 3304 read program code from one or more non-transitory media and execute the code to enable the computer system to accomplish the methods performed by the embodiments herein. Those skilled in the art will understand that the processor(s) may ingest source code, and interpret or compile the source code into machine code that is understandable at the hardware gate level of the processor(s) 3304. The processor(s) 3304 may include dedicated processors such as microcontrollers running firmware. The processor(s) 3304 may include specialized processing units (e.g., GPUs, FPGAs, ASICs) for handling specialized or computationally intensive tasks.

The processor(s) 3304 may communicate with external networks via one or more communications interfaces 3307, such as a network interface card, WiFi transceiver, etc. One or more bus systems 3305 communicatively couple the I/O subsystem 3302, the processor(s) 3304, peripheral devices 3306, communications interfaces 3307, main memory 3308, and secondary memory 3310. Embodiments of the disclosure are not limited to this representative architecture. Alternative embodiments may employ different arrangements and types of components, e.g., separate buses for input-output components and memory subsystems, or different arrangement and types of computer systems (e.g., multiple computer systems together executing program code to perform the methods described in the embodiments herein). Elements of embodiments of the disclosure, such as one or more servers (e.g., in the cloud) communicating with an app, may be implemented with at least some of the components (e.g., processor 3304, main memory 3308, communication interfaces 3307) of a computer system like that of computer system 3300.

Those skilled in the art will understand that some or all of the elements of embodiments of the disclosure, and their accompanying operations, may be implemented wholly or partially by one or more computer systems including one or more processors and one or more memory systems like those of computer system 3300. Some elements and functionality may be implemented locally and others may be implemented in a distributed fashion over a network through different servers, e.g., in client-server fashion, for example.

Those skilled in the art will recognize that, in some embodiments, some of the operations described herein that do not involve data processing may be performed by human implementation, or through a combination of automated and manual means.

Although the disclosure may not expressly disclose that some embodiments or features described herein may be combined with other embodiments or features described herein, this disclosure should be read to describe any such combinations that would be practicable by one of ordinary skill in the art. Unless otherwise indicated herein, the term “include” shall mean “include, without limitation,” and the term “or” shall mean non-exclusive or in the manner of “and/or.”

In the claims below, a claim reciting “any one of claims X-Y” shall refer to any one of claims from claim X and ending with claim Y (inclusive). For example, “The system of any one of claims 7-11” refers to the system of any one of claims 7, 8, 9, 10, and 11.

### INCORPORATION BY REFERENCE

All references cited herein, including, without limitation, articles, publications, patents, patent publications, and patent applications, are incorporated by reference in their entireties for all purposes, except that any portion of any such reference is not incorporated by reference to the extent that it: (1) is inconsistent with embodiments of the disclosure expressly described herein; (2) limits the scope of any embodiments described herein; or (3) limits the scope of any terms of any claims recited herein Mention of any reference cited herein is not an acknowledgment that it constitutes valid prior art, or that it discloses essential matter.

### EMBODIMENTS

Each embodiment set (A, B, . . . ) below includes dependent embodiments that are dependent on embodiments within the same embodiment set.

### Embodiment Set A

1. A jig for providing a position reference for an image-based positioning system, the jig comprising:
a plate, wherein
the plate comprises a region to provide access to a workpiece during use, at least a first portion of the plate rests on the workpiece during use,
the plate comprises one or more features on a second portion of the plate, each feature of the one or more features having an attribute to permit identification of the corresponding feature relative to the other features,
the plate comprises a first element to permit alignment of the plate relative to a first plane associated with an edge of the workpiece, the first element has a thickness, in a first state of the first element, that is less than or equal to a thickness of the plate, and
the plate comprises a second element to permit alignment of the plate relative to a second plane associated with a second edge of the workpiece when used in combination with the first element, the second plane is not parallel to the first plane, the second element has a thickness, in a first state of the second element, that is less than or equal to the plate thickness.
2. The jig of embodiment 1, wherein the plate has a top planar surface area, and the plate thickness is less than 20 mm, 15 mm, 10 mm, 8 mm, 6 mm, 5 mm, or 4 mm across 50%, 60%, 70%, 80%, 90% or more of the top planar surface area.
3. The jig of embodiment 2 or 3, wherein the first element permits alignment of the plate to the edge of the workpiece by visually aligning the first element to the workpiece edge.
4. The jig of embodiment 2 or 3, wherein the first element permits alignment of the plate to the edge of the workpiece by mechanically aligning the first element to the workpiece edge.
5. The jig of embodiment 4, wherein the first element comprises an alignment surface, the alignment surface, in the first state of the first element, does not protrude beyond a top or a bottom surface of the plate, the alignment surface, in a second state of the first element, protrudes beyond the top or the bottom surface of the plate, and the alignment surface contacts the workpiece edge when the first element is mechanically aligned to the workpiece edge.
6. The jig of embodiment 5, wherein the first element retracts from the second state to the first state using a spring mechanism.
7. The jig of embodiment 5 or 6, wherein a plane defined by the alignment surface intersects the region when the first element is in the second state.
8. The jig of any one of the preceding embodiments, wherein the plate comprises a clamp mechanical interface, the clamp mechanical interface permits a clamp to removably couple to the plate, the clamp mechanical interface has a maximum thickness relative to the plate thickness, and the clamp mechanical interface maximum thickness is less than or equal to the plate thickness.
9. The jig of embodiment 8, wherein the clamp mechanical interface comprises a first region to permit entry of a first component of the clamp into the clamp mechanical interface, and the clamp mechanical interface comprises a second region that restricts removal of the first component of the clamp when the first component of the clamp is in the second region.
10. The jig of embodiment 8 or 9, wherein the clamp is operable to rotate by 45 degrees, 90 degrees, 180 degrees, 270 degrees, 360 degrees, or more when coupled to the plate using the clamp mechanical interface.
11. The jig of any one of the preceding embodiments, wherein the second element comprises a second alignment surface, the second alignment surface, in the first state of the second element, does not protrude beyond a top or a bottom surface of the plate, and the second alignment surface, in a second state of the second element, protrudes beyond the top or the bottom surface of the plate.
12. The jig of embodiment 11, wherein the second element remains in the first state based on a magnetic force applied on the second element.
13. The jig of embodiment 11 or 12, wherein the second element remains in the second state based on a magnetic force applied on the second element.
14. The jig of any one of embodiments 11-13, wherein the first element and the second element share a common design.
15. The jig of any one of the preceding embodiments, wherein the plate comprises a third element, and the third element protrudes into the region when the third element is in a first state.
16. The jig of embodiment 15, wherein the third element comprises a fiducial indicating a position of the first or second element.
17. The jig of any one of the preceding embodiments, wherein the plate is larger than 200 mm, 250 mm, 300 mm, 350 mm, 400 mm, 450 mm, or 500 mm along a first dimension, and the plate is larger than 200 mm, 250 mm, 300 mm, 350 mm, 400 mm, 450 mm, or 500 mm in a second dimension.
18. The jig of any one of the preceding embodiments, wherein the region is larger than 50 mm, 100 mm, 150 mm, or 200 mm along a first dimension, and the region is larger than 50 mm, 100 mm, 150 mm, or 200 mm along a second dimension.
19. The jig of any one of the preceding embodiments, wherein each feature of the one or more features comprises a machine-readable marker, and each machine-readable marker has a marker ID.
20. The jig of embodiment 19, wherein each feature has a marker ID which is different from marker IDs of the other features.
21. A computer-implemented method for using a jig to perform a task on a workpiece using a tool, the method comprising:
scanning a first portion of a surface of the jig to capture first image data, wherein the first image data comprises information related to one or more features visible on a first portion of the surface;
accessing feature information, wherein the feature information is created before scanning the first portion of the surface, and the feature information relates to position information for the one or more features;
accessing jig design information, wherein the jig comprises a region to access the workpiece, and the jig design information comprises position information for the region;
determining a position of a component of the tool, wherein the position is determined based at least in part upon the captured first image data and the feature information; and
triggering an action based on the position of the component relative to the region based at least in part upon the jig design information.
22. The method of embodiment 21, wherein the tool comprises a spindle, the component is a cutting bit, and the action is one or more of: turning the spindle off, moving the cutting bit away from an edge of the region, lifting the cutting bit away from the jig, sounding an audible alarm, or displaying a message on a GUI of a display.
23. The method of embodiment 21, further comprising:
scanning a second portion of the surface of the jig to capture second image data, wherein the second image data comprises information related to one or more features on the second portion of the surface; and
determining the feature information based at least in part upon the captured second image data, wherein the feature information is determined before accessing the feature information.
24. The method of embodiment 21, further comprising:
identifying the jig design information based at least in part upon the captured first image data or the feature information.
25. The method of embodiment 21, further comprising:
probing one or more datum points on the jig; and
determining the position of the one or more datum points in a coordinate system, wherein the position of the one or more datum points is based at least in part upon the feature information.
26. The method of embodiment 25, wherein the position of the component of the tool is determined in the coordinate system.
27. The method of embodiment 21, further comprising:
registering a digital design to one or more features included in the feature information, wherein at least a portion of the digital design is in the region.
28. The method of embodiment 27, wherein the jig comprises a first element to permit alignment of the jig to the workpiece, and the digital design is registered based at least in part upon a position of the first element of the jig.
29. A system for using a jig to perform a task on a workpiece using a tool, the system comprising:
a jig having one or more features visible on a surface of the jig;
one or more processors;
a camera operably coupled to a respective at least one of the one or more processors;
one or more actuators operable to move a component of the tool; and
one or more memories each operably coupled to a respective at least one of the one or more processors, wherein at least one of the one or more memories comprise instructions that, when executed by at least one of the one or more processors, cause the system to:
scan a first portion of the surface of the jig to capture first image data using the camera, wherein the first image data comprises information related to one or more features visible on a first portion of the surface;
access feature information, wherein the feature information is created before the first portion of the surface is scanned, and the feature information relates to position information for the one or more features visible on the surface;
access jig design information, wherein the jig comprises a region to access the workpiece, and the jig design information comprises position information for the region;
determine a position of the component of the tool, wherein the position is determined based at least in part upon the captured first image data and the feature information; and
trigger an action based on the position of the component relative to the region based at least in part upon the jig design information.
30. One or more non-transitory computer-readable media storing instructions for using a jig to perform a task on a workpiece using a tool, wherein the instructions, when executed by one or more computing devices, cause at least one of the one or more computing devices to:
scan a first portion of a surface of the jig to capture first image data, wherein the first image data comprises information related to one or more features visible on a first portion of the surface;
access feature information, wherein the feature information is created before scanning the first portion of the surface, and the feature information relates to position information for the one or more features;
access jig design information, wherein the jig comprises a region to access the workpiece, and the jig design information comprises position information for the region;
determine a position of a component of the tool, wherein the position is determined based at least in part upon the captured first image data and the feature information; and
trigger an action based on the position of the component relative to the region based at least in part upon the jig design information.
31. A computer-implemented method for using a jig to perform a task on a workpiece using a tool, the method comprising:
scanning a first portion of a surface of the jig to capture first image data, wherein the first image data comprises information related to one or more features visible on a first portion of the surface;
accessing feature information, wherein the feature information is created before scanning the first portion of the surface, and the feature information relates to position information for the one or more features;
accessing jig design information, wherein the jig comprises a region to access the workpiece, and the jig design information comprises position information for the region;
registering a digital design to the one or more features based on the feature information, wherein at least a portion of the digital design is in the region;
determining a position of a component of the tool, wherein the position is determined based at least in part upon the captured first image data and the feature information; and
providing information to cause the component of the tool to move to a target position on a path, wherein the path is based at least in part upon the registered digital design.
32. The method of embodiment 31, wherein the jig comprises a first element to permit alignment of the jig to the workpiece, and the digital design is registered based at least in part upon a position of the first element on the jig.
33. A system for using a jig to perform a task on a workpiece using a tool, the system comprising:
a jig having one or more features visible on a surface of the jig;
one or more processors;
a camera operably coupled to a respective at least one of the one or more processors;
one or more actuators operable to move a component of the tool; and
one or more memories each operably coupled to a respective at least one of the one or more processors, wherein at least one of the one or more memories comprise instructions that, when executed by at least one of the one or more processors, cause the system to:
scan a first portion of the surface of the jig to capture first image data using the camera, wherein the first image data comprises information related to one or more features visible on a first portion of the surface;
access feature information, wherein the feature information is created before the first portion of the surface is scanned, and the feature information relates to position information for the one or more features visible on the surface;
access jig design information, wherein the jig comprises a region to access the workpiece, and the jig design information comprises position information for the region;
register a digital design to the one or more features visible on the surface based on the feature information, wherein at least a portion of the digital design is in the region;
determine a position of the component of the tool, wherein the position is determined based at least in part upon the captured first image data and the feature information; and
provide information to cause the one or more actuators to move the component of the tool to a target position on a path, wherein the path is based at least in part upon the registered digital design.
34. One or more non-transitory computer-readable media storing instructions for using a jig to perform a task on a workpiece using a tool, wherein the instructions, when executed by one or more computing devices, cause at least one of the one or more computing devices to:
scan a first portion of a surface of the jig to capture first image data, wherein the first image data comprises information related to one or more features visible on a first portion of the surface;
access feature information, wherein the feature information is created before scanning the first portion of the surface, and the feature information relates to position information for the one or more features;
access jig design information, wherein the jig comprises a region to access the workpiece, and the jig design information comprises position information for the region;
register a digital design to the one or more features based on the feature information, wherein at least a portion of the digital design is in the region;
determine a position of a component of the tool, wherein the position is determined based at least in part upon the captured first image data and the feature information; and
provide information to cause the component of the tool to move to a target position on a path, wherein the path is based at least in part upon the registered digital design.
35. The jig of any one of embodiments 5-20, wherein the alignment surface of the first element does not protrude more than 20 mm, 15 mm, 10 mm, 8 mm, 6 mm, 5 mm, or 4 mm beyond the top or the bottom surface of the plate during a transition of the first element from the first state to the second state or vice versa.
36. The jig of any one of embodiments 11-20, wherein the second alignment surface of the second element does not protrude more than 20 mm, 15 mm, 10 mm, 8 mm, 6 mm, 5 mm, or 4 mm beyond the top or the bottom surface of the plate during a transition of the second element from the first state or the second state or vice versa.

### Embodiment Set B

1. A jig for providing a position reference for an image-based positioning system, the jig comprising:
a plate, wherein
the plate comprises a region to provide access to a workpiece during use, at least a first portion of the plate rests on the workpiece during use,
the plate comprises one or more features on a second portion of the plate, each feature of the one or more features having an attribute to permit identification of the corresponding feature relative to the other features, and
the plate comprises a clamp mechanical interface, the clamp mechanical interface permits a clamp to removably couple to the plate, the clamp mechanical interface has a maximum thickness relative to a thickness of the plate, and the clamp mechanical interface maximum thickness is less than or equal to the plate thickness.
2. The jig of embodiment 1, wherein the clamp mechanical interface comprises a first region to permit entry of a first component of the clamp into the clamp mechanical interface, and the clamp mechanical interface comprises a second region that restricts removal of the first component of the clamp when the first component of the clamp is in the second region.
3. The jig of embodiment 2, wherein the clamp is operable to rotate by 45 degrees, 90 degrees, 180 degrees, 270 degrees, 360 degrees, or more when coupled to the plate using the clamp mechanical interface.

### Embodiment Set C

1. A clamp comprising:
a clamp bar comprising a clamp head, wherein the clamp head removably couples to a mechanical interface on an object;
a coupling bar coupled to the clamp bar;
a clamping mechanism coupled to the coupling bar.
2. The clamp of embodiment 1, wherein the coupling bar is movably coupled to the clamp bar.
3. The clamp of embodiment 1 or 2, wherein the clamping mechanism comprises a screw clamp.
4. The clamp of embodiment 3, wherein the screw clamp comprises a torque limiting mechanism.
5. The clamp of embodiment 1 or 2, wherein the clamping mechanism comprises a ratcheting lever clamp.
6. The clamp of any one of the preceding embodiments, wherein the clamping mechanism comprises a sprung clamp pad.
7. The clamp of any one of the preceding embodiments, wherein the coupling bar comprises a cutout.
8. The clamp of any one of the preceding embodiments, wherein the mechanical interface is a keyhole interface.
9. The clamp of any one of the preceding embodiments, wherein the object is a plate.
10. The clamp of embodiment 9, wherein the clamp head does not protrude above a top surface of the plate after the clamp is coupled to the plate using the mechanical interface.
11. The clamp of embodiment 9 or 10, wherein the clamp is operable to rotate more than 90, 180, 270, or 360 degrees about an axis parallel to the clamp bar after the clamp is coupled to the plate using the mechanical interface.
12. The clamp of embodiment 9 or 10, wherein the clamp is operable to rotate by 45 degrees, 90 degrees, 180 degrees, 270 degrees, 360 degrees, or more when coupled to the plate using the mechanical interface

1. A jig for providing a position reference for an image-based positioning system, the jig comprising:
a plate, wherein
the plate comprises a region to provide access to a workpiece during use, at least a first portion of the plate rests on the workpiece during use,
the plate comprises one or more features on a second portion of the plate, each feature of the one or more features having an attribute to permit identification of the corresponding feature relative to the other features,
the plate comprises a first element to permit alignment of the plate relative to a first plane associated with an edge of the workpiece, the first element has a thickness, in a first state of the first element, that is less than or equal to a thickness of the plate, and
the plate comprises a second element to permit alignment of the plate relative to a second plane associated with a second edge of the workpiece when used in combination with the first element, the second plane is not parallel to the first plane, the second element has a thickness, in a first state of the second element, that is less than or equal to the plate thickness.

2. The jig of claim 1, wherein the plate has a top planar surface area, and the plate thickness is less than 10 mm, 8 mm, 6 mm, 5 mm, or 4 mm across 50%, 60%, 70%, 80%, 90% or more of the top planar surface area.

3. The jig of claim 2, wherein the first element permits alignment of the plate to the edge of the workpiece by mechanically aligning the first element to the workpiece edge.

4. The jig of claim 3, wherein the first element comprises an alignment surface, the alignment surface, in the first state of the first element, does not protrude beyond a top or a bottom surface of the plate, the alignment surface, in a second state of the first element, protrudes beyond the top or the bottom surface of the plate, and the alignment surface contacts the workpiece edge when the first element is mechanically aligned to the workpiece edge.

5. The jig of claim 4, wherein the first element retracts from the second state to the first state using a spring mechanism.

6. The jig of claim 4, wherein a plane defined by the alignment surface intersects the region when the first element is in the second state.

7. The jig of claim 2, wherein the plate comprises a clamp mechanical interface, the clamp mechanical interface permits a clamp to removably couple to the plate, the clamp mechanical interface has a maximum thickness relative to the plate thickness, and the clamp mechanical interface maximum thickness is less than or equal to the plate thickness.

8. The jig of claim 7, wherein the clamp mechanical interface comprises a first region to permit entry of a first component of the clamp into the clamp mechanical interface, and the clamp mechanical interface comprises a second region that restricts removal of the first component of the clamp when the first component of the clamp is in the second region.

9. The jig of claim 8, wherein the clamp is operable to rotate by 180 degrees, 270 degrees, 360 degrees, or more when coupled to the plate using the clamp mechanical interface.

10. The jig of claim 2, wherein the second element comprises a second alignment surface, the second alignment surface, in the first state of the second element, does not protrude beyond a top or a bottom surface of the plate, and the second alignment surface, in a second state of the second element, protrudes beyond the top or the bottom surface of the plate.

11. The jig of claim 10, wherein the second element remains in the first state based on a magnetic force applied on the second element.

12. The jig of claim 11, wherein the second element remains in the second state based on a magnetic force applied on the second element.

13. The jig of claim 12, wherein the first element and the second element share a common design.

14. The jig of claim 2, wherein the plate comprises a third element, and the third element protrudes into the region when the third element is in a first state.

15. The jig of claim 14, wherein the third element comprises a fiducial indicating a position of the first or second element.

16. The jig of claim 2, wherein the plate is larger than 300 mm, 350 mm, 400 mm, 450 mm, or 500 mm along a first dimension, and the plate is larger than 200 mm, 250 mm, 300 mm, 350 mm, 400 mm, 450 mm, or 500 mm in a second dimension.

17. The jig of claim 2, wherein the region is larger than 50 mm, 100 mm, 150 mm, or 200 mm along a first dimension, and the region is larger than 50 mm, 100 mm, 150 mm, or 200 mm along a second dimension.

18. The jig of claim 2, wherein each feature of the one or more features comprises a machine-readable marker, and each machine-readable marker has a marker ID.

19. The jig of claim 18, wherein each feature has a marker ID which is different from marker IDs of the other features.

20. The jig of claim 4, wherein the alignment surface of the first element does not protrude more than 20 mm, 15 mm, 10 mm, 8 mm, 6 mm, 5 mm, or 4 mm beyond the top or the bottom surface of the plate during a transition of the first element from the first state to the second state or vice versa.
